(19) United States
(12) Patent Application Publication
(10) Pub. No.: US 2025/0013437 A1
(43) Pub. Date: Jan. 9, 2025

(54) Just-In-Time Programming Framework with Large Language Models and Flow-Based Programming

(71) Applicant: Composable Analytics, Inc., Cambridge, MA (US)

(72) Inventors: Andy Vidan, Newton, MA (US); Lars Henry Fiedler, Lexington, MA (US)

(73) Assignee: Composable Analytics, Inc., Cambridge, MA (US)

(21) Appl. No.: 18/759,951

(22) Filed: Jun. 30, 2024

Related U.S. Application Data
(60) Provisional application No. 63/540,580, filed on Sep. 26, 2023.
(60) Provisional application No. 63/524,835, filed on Jul. 3, 2023.

(51) Int. Cl. G06F 8/33; G06F 8/34; G06F 40/284

(52) U.S. Cl. CPC G06F 8/33; G06F 8/34; G06F 40/284

(57) ABSTRACT

A programming system to create programs. Data are stored that describe actions of the users in creating the programs. The programming system has a library of templates for functions. A graphical user interface presents to users functions depicted as templates of blocks to be selected for incorporation into programs. Users direct the system to assemble functions from the set into the programs. The graphical user interface depicts the incorporated functions as graphical elements for manipulation in the graphical user interface. Users can graphically connect data output connection points of incorporated function graphical elements to input connection points of incorporated function graphical elements. A trained artificial intelligence large language model has been trained with a corpus of graphical programs to compute suggestions to the user for functions to be added into the program. The computation of function suggestion is based at least in part on a prompt given by the user and the trained large language model.

### BACKGROUND

This application claims benefit, as a non-provisional of U.S. Provisional application Ser. No. 63/540,580, filed Sep. 26, 2023, and claims benefit as a non-provisional of U.S. Provisional application Ser. No. 63/524,835, filed Jul. 3, 3023, both titled Just-In-Time Programming Framework with Large Language Models and Flow-Based Programming, both incorporated by reference. The auxiliary PDF filed herewith is incorporated by reference.

This application relates to software program development tools for code generation.

Known programming systems present the user with a set of functional block templates, and tools for connecting those blocks together to form programs. This programming paradigm is called Flow-Based Programming, with the programs called “flow-based programs” or simply “programs”.

### SUMMARY

In general, in a first aspect, the invention features a method, and a computer with instructions for performance of the method. One or more processors are designed to execute instructions from a memory. One or more computer-readable nontransitory memories have stored therein instructions to cause the processor(s) to perform the following steps. Users of a programming system use the programming system to create programs. Data are stored that describe actions of the users in creating the programs. The programming system has a graphical user interface. The programming system has a library of templates for functions. The graphical user interface presents to users functions depicted as templates of blocks to be selected for incorporation into programs. The graphical user interface is programmed to receive input from the users to direct the system to assemble functions from the set into the programs. The functions are functions for processing of data. The graphical user interface depicts the incorporated functions as graphical elements for manipulation in the graphical user interface. The graphical user interface presents an ability to graphically connect data output connection points of incorporated function graphical elements to input connection points of incorporated function graphical elements. A trained artificial intelligence large language model has been trained with a corpus of graphical programs to compute suggestions to the user for functions to be added into the program. The computation of function suggestion is based at least in part on a prompt given by the user and the trained large language model.

Embodiments of the invention may include one or more of the following features. These features may be used singly, or in combination with each other. As the user assembles functions from the set into a program, the system may execute a partially-assembled program on input data. The programming system may compute suggestions to the user for functions to be added into the program based at least in part on the execution of the partially-assembled program. The corpus of existing graphical programs may be annotated with metadata to provide context for incorporation into programs to be created. The corpus of existing graphical programs may be tokenized to integer IDs. The function templates of the corpus may specify inputs and outputs, the inputs and outputs being strongly typed. The programming system may compute the function suggestions based at least in part on the types of inputs and/or outputs of the functions in the program. The programming system may compute a training objective that minimizes negative log-likelihood of suggested actions. The programming system may gather feedback for retraining of the artificial intelligence large language model.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIGS. 1a and 7A are block diagrams of a computer system.

FIGS. 1b to 2g, 3A to 3C, 4A, 4B, 5, 6, 7B, 8A, 8B, 9A, and 9B are screen shots from execution of a program.

### DESCRIPTION

### The Description is Organized as Follows.

### I. Overview

I.A. Functional components
I.B. Just-In-Time Programming
I.C. Uses and advantages of Just-in-Time Programming

### II. Examples

II.A. Example 1
II.B. Example 2: Simple, Just-In-Time Arithmetic
II.C. Example 3: Primality Test
II.D. Example 4: Generating New Data
II.E. Example 5: Table Manipulation
II.F. Example 6: adding two integer inputs
II.G. Example 7: a calculator
   III. Application of Large Language Model technology to Flow-Based Programming
III.A. Large Language Models
III.B. Just-in-Time Programming Platform
III.C. Just-in-Time Programming Demonstration
   III.C.1. JIT Code Generation Module
   III.C.2. Setting Up the API Environment
   III.C.3. API Request Construction
   III.C.4. Making the API Request and handling the result
   III.C.5. Integration into the Workflow
   III.C.6. Purpose-built LLM
   III.C.7. Improving reliability of automated code generation
III.D. Steps
III.E. Data Collection and Preparation
III.F. Fine-Tuning Process
III.G. Integration and Deployment
   IV. Fine-tuning pre-trained LLM for Composable DataFlow Code Generation
IV.A. Mathematical Formulation
IV.B. Approach

### V. Implementation

### I. Overview

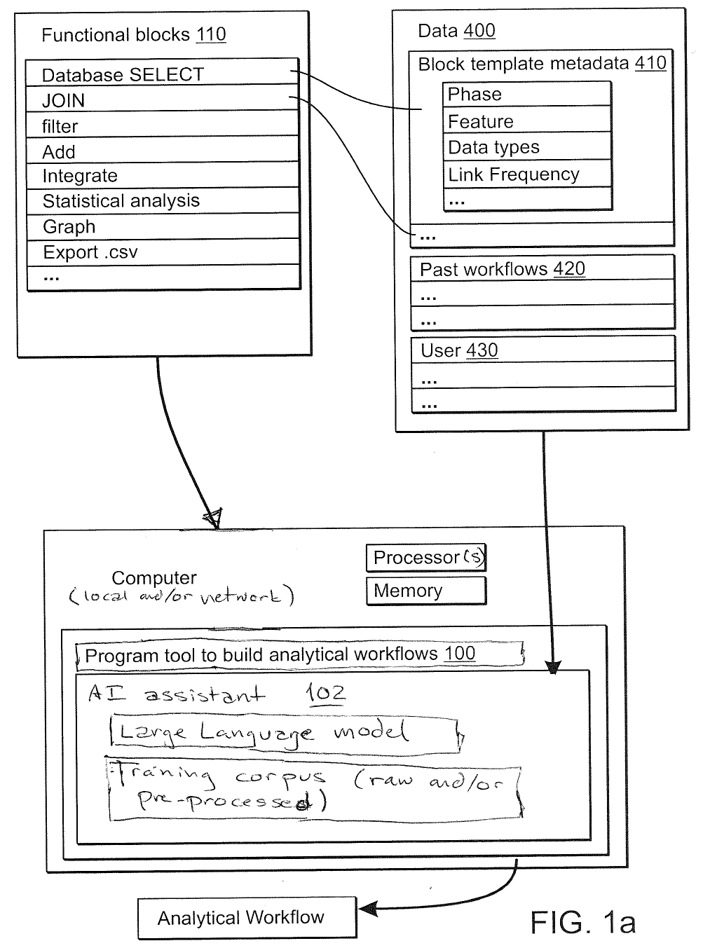

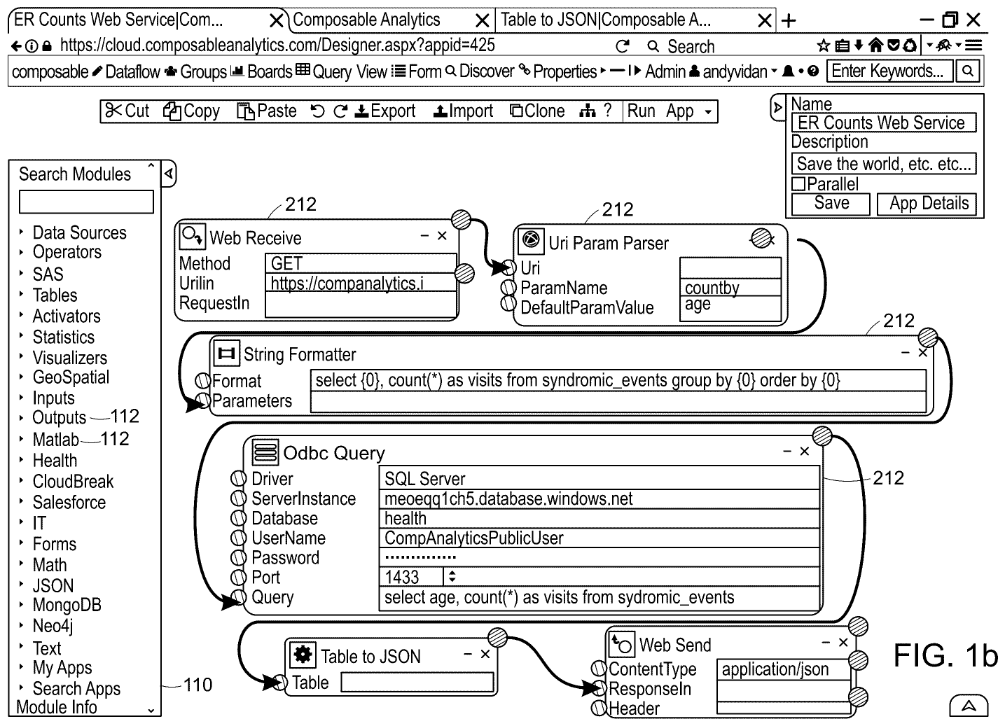

Referring to FIGS. 1a and 1b, in a programming system 100 for flow-based programming provides a library 110 of templates for functional blocks 112. Each block template 112 specifies a functional block, with its function, inputs and outputs, and other properties. The graphical user interface allows a user to select block templates 112, instantiates selected templates as specific functional blocks 212, and allows the user to connect outputs from one block 212 as inputs to the next. Programming system 100 may include an AI assistant 102 to help build flow-based programs by recommending a short list of suggested next actions to the user, so that the user need not sift through the large library 110 for the next action to be taken. AI assistant 102 may collect information from a number of sources, including annotation information describing the available block templates 112, information derived from and about previously built flow-based programs, information about this user, and information about other users and their use of the system. AI assistant 102 may process this information to build a historical profile for each specific user that records what that user has done in the past. When the user uses the programming system 100 to build a new program, AI assistant 102 may call on this learned data to infer what the user is likely to want to do next, and use that inference to recommend next actions to the user. Because the full set of available block templates 112 may be very large, singling out a set of more-probable recommendations tends to save time for a user, by relieving the user of the burden of scrolling through a large menu 110 of block templates 112. Likewise, AI assistant 102 may assist by recommending specific edges to the graph, to connect the blocks. Likewise, a user may issue a prompt to AI assistant 102 specifying a function to be performed, and AI assistant may 102 return code to be plugged into the program under development. AI assistant 102 may be implemented as a trained large language model.

Programming system 100 may accelerate the process of developing flow-based programs by providing a scripting language and/or a visual approach for assembling and connecting functional blocks. One such system, called Composable DataOps Platform from Composable Analytics, Inc. of Cambridge, Mass., is a web-based tool that allows users to author complex programs using a visual approach and a flow-based programming methodology. Programming system 100 may provide a library 110 of block templates 112 or modules. Each block template 112 is analogous to a function in a traditional programming language: each function may have zero or more inputs, may perform some execution step such as computing some function of its inputs, and produce one or more outputs. Programming system 100 may assist a user in selecting block templates 112 to instantiate as functional blocks 212, and connecting outputs of one functional block 212 as inputs to other functional blocks 212. Programming system 100 may assist a user in building a flow-based program represented as a flow-based diagram, for example, a directed graph with functional blocks as the nodes. The connections between functional blocks may be shown as data flow edges. Each functional block may perform one or more of the tasks required for the program, from a simple mathematical computation on a set of inputs, to ingestion of data, to data preparation, to fusion of data from incompatible sources, to advanced analytical functions that facilitate exploitation of data. A completed program may step through the entire process of performing the extraction, transformation, loading, querying, visualization, and dissemination of the data.

AI assistant 102 may make automated recommendations to accelerate the development of correct program. The technology does not require any specific programming system, but can be used in a variety of programming systems that work with functions and flow between them, whether represented as data flow graphs or similar graphical representations of programs, text, or other program representations.

Integrating Flow-Based Programming and Large Language Models (LLMs) may yield a combination that may be called “Just-In-Time Programming.” The Just-In-Time Programming framework may enable real-time task automation and algorithm implementation, empowering users to develop and implement algorithms in real time. The framework's cloud-based architecture, graphical user interface, collaboration tools, and extensibility may permit rapid software development for tasks that are complex, and rapid re-development where the requirements change.

### I.A. Functional Components

An implementation of a Just-In-Time Programming framework may include several components. A Data Ingestion Layer may be responsible for collecting and preprocessing real-time data from various sources. The Data Ingestion Layer may collect data from multiple sources such as sensors, user inputs, and external APIs. Data may be ingested through a message broker system to improve scalability and reliability. Data may be cleaned, normalized, and transformed into a format suitable for processing. Preprocessing steps may include removing duplicates, handling missing values, and applying necessary transformations (e.g., scaling, encoding).

A Flow-Based Programming Engine may manage task flows, where each task is represented as a node in a directed graph, and data flows between nodes. The Flow-Based Programming Engine may define a workflow as a graph of one or more tasks. Each task may be defined as a node with specific input and output requirements. Nodes can be basic operations (e.g., data transformation, filtering) or complex tasks (e.g., data analysis, report generation). Nodes may be connected to form a directed acyclic graph (DAG), representing the workflow. Edges define the data flow between nodes, the edges of the graph specify correct sequence of the execution of the tasks of the workflow. Nodes may be dynamically added, removed, or modified based on real-time data and user requirements. The user may change the program by changing the graph, whereby the system allows a user and program to adapt to new tasks and workflows.

A Large Language Model Integration component may use one or more pre-trained LLMs to generate task instructions and perform language-based tasks. Large Language Model Integration may integrate a pre-trained LLM (e.g., OpenAI's GPT-4) into the framework. A suitable model may be selected based on its ability to understand and generate human-like text that instructs instructions based on input data, predefined templates, and context. Contextual understanding may be achieved through fine-tuning the models on domain-specific data.

A Task Execution Engine may execute generated tasks in real time, either sequentially or through parallel execution of tasks. The engine may manage computational resources, allocating them based on task priority and complexity.

A Feedback Loop may continuously monitor task execution and feed back data for model retraining and optimization. A Just-In-Time Programming system may provide feedback through continuous monitoring of task execution and logging of performance metrics.

Monitoring may include task completion time, resource utilization, and error rates. Feedback data may be used to retrain the LLMs and optimize the Flow-Based Programming graph. Retraining may improve the accuracy and relevance of task instructions. Optimization may involve refining node connections and data flows to enhance system performance. Anomaly detection algorithms may identify and address deviations in task execution, and initiate corrective actions to maintain system reliability.

### I.B. Just-In-Time Programming

Just-In-Time Programming may provide a framework that provides a structured approach to building software applications that is responsive to any user input. A Just-in-Time Programming framework may be based on integration of Flow-Based Programming techniques and Large Language Models.

Flow-Based Programming offers a structured, modular and reactive workflow model that aligns well with the dynamic nature of task execution and algorithm implementation. Similarly, Large Language Models (LLMs) allows for the expressive capacity to represent and manipulate any computable function.

Flow-Based Programming is a programming paradigm that focuses on the flow of data between components, emphasizing modularity, reusability, and reactive processing. In Flow-Based Programming, the execution of a program is driven by the flow of data, rather than being strictly controlled by a predefined sequence of operations.

Flow-Based Programming may have the following advantages. Flow-Based Programming encourages breaking down a system into smaller, self-contained components. These components have well-defined inputs and outputs, facilitating modularity, code reuse, and easy maintenance. Flow-Based Programming emphasizes the flow of data streams between components.

Components can receive input data, process it, and produce output data that is then passed to downstream components. The connections between components define the flow of data, allowing for flexible and reactive execution. Flow-Based Programming may promote an asynchronous and reactive execution model. Components react to incoming data, processing it as soon as it becomes available, enabling real-time responsiveness and dynamic task adaptation.

The integration of Flow-Based Programming with large language models within the Just-In-Time Programming framework offers several benefits that enhance task-time development:
(a) Modularity and Reusability: Flow-Based Programming's component-based design fosters modularity and code reusability. Components can be easily connected and combined, allowing users to create flexible and scalable solutions. This modularity also enables incremental development and iterative improvements, aligning well with the Just-In-Time Programming approach.
(b) Dynamic Task Adaptation: Flow-Based Programming's reactive execution model enables components to react to incoming data in real-time. This flexibility allows for dynamic task adaptation, where the solution can adjust and respond to changing task requirements or data inputs. Just-In-Time Programming leverages this adaptability to accommodate evolving user needs and algorithmic insights during task execution.
(c) Scalability and Parallelism: Flow-Based Programming inherently supports parallel processing and scalability. By leveraging the flow of data between components, tasks can be distributed across multiple processing units, improving performance and efficiency. This scalability is particularly beneficial when dealing with computationally intensive tasks or large datasets.
(d) Visualization of Control Flow and Debugging: Flow-Based Programming frameworks often provide graphical or visual representations of the data flow and component connections, facilitating visualization and debugging of the automation solution. This visual feedback enhances user understanding and aids in identifying and resolving issues during algorithm implementation. The flowchart-like diagrams make it easier to comprehend the program's logic and control structures. This visualization aids in understanding the program's intended behavior, making it less prone to errors and enabling better accuracy during development and debugging.
(e) Clear Representation of Data Flow: Visual flow-based programming emphasizes the flow of data between different components. By explicitly representing data connections and transformations, it becomes easier to track and validate the data flow within the program. This clarity helps in ensuring correctness and identifying potential issues or bugs related to data handling.
(f) Reduced Functional Errors: Since the logic is constructed using pre-built functional components, flow-based programs reduce the potential for underlying errors in the required functions and improve the overall correctness.
(g) Simpler Debugging Process: When debugging visual flow-based programs, it is often easier to identify and isolate errors. The graphical representation allows developers to visually trace the execution path, track data flow, and identify problematic areas. This case of debugging helps in identifying and rectifying issues more efficiently, resulting in improved correctness and accuracy.

### I.C. Uses and Advantages of Just-In-Time Programming

A Just-in-Time Programming framework may integrate Flow-Based Programming techniques with Large Language Models. This integration may enable users to express their algorithmic insights in real time, automate tasks, and rapidly prototype software solutions. The versatility of a Just-in-Time Programming platform may extend across various domains and use cases. In data science and analytics, users can leverage LLMs to generate code for data preprocessing, feature engineering, and model evaluation, while orchestrating complex data workflows with Flow-Based Programming principles. In software development, a Just-in-Time Programming platform may facilitate rapid prototyping, automate repetitive tasks, and allow for the development of large, microservices-based architectures, with integration of LLM-generated code within the larger codebase. Additionally, a Just-in-Time Programming platform may find applications in natural language processing, machine learning, robotic process automation, and more, where the combination of LLMs and Flow-Based Programming principles offers unparalleled flexibility and agility.

Just-In-Time Programming may offer a user-centric approach to programming by allowing algorithm implementation during task execution. By aligning software functionality with dynamic user requirements, Just-In-Time Programming may empower users to leverage their algorithmic insights and implement tasks and subtasks in real-time. A Just-In-Time Programming framework may be based on integration of flow-based programming techniques and Large Language Models. LLMs may generate immediate implementation of algorithms and Flow-Based Programming may orchestrate task completion in real-time.

Just-In-Time Programming may take a task-oriented focus, where the development framework allows users concentrate on task completion as the primary goal. The Just-in-Time Programming framework may allow users to envision algorithms to complete subtasks and improve efficiency, and enable the immediate implementation of these algorithms, leveraging the user's insights and enhancing task completion in real-time.

Just-In-Time Programming may enable users to develop and program tasks while they are in progress. This dynamic and adaptive nature may allow for real-time adjustments to meet evolving requirements, making computing more responsive and aligned with immediate user needs. Just-In-Time Programming may leverage user insights and domain expertise, resulting in tailored solutions that optimize task completion efficiency.

Just-In-Time Programming places the user at the center of the programming process. Whether the user is a novice or an experienced programmer, Just-In-Time Programming enables individuals to recognize algorithmic opportunities during task execution and implement them just in time. This user-centric approach may empower non-programmers and reduce reliance on dedicated software development teams, fostering a more inclusive and efficient computing environment.

By developing, implementing and automating potential computer subtasks during task execution, Just-In-Time Programming may significantly enhance productivity. Just-In-Time Programming may allow users to capitalize on their algorithmic insights immediately, resulting in faster and more efficient task completion.

Just-In-Time Programming may allow users to gain a deeper understanding of their tasks and subtasks. By actively engaging with the programming process during task execution, users may become more aware of the underlying algorithms and automation possibilities within their domain. This heightened understanding can lead to innovative solutions, as users are more likely to identify new approaches and optimize existing ones based on their firsthand experience.

Just-In-Time Programming may be useful in environments characterized by rapidly changing requirements and dynamic task execution. As tasks evolve or new insights emerge, Just-In-Time Programming may allow users to quickly modify and extend their implemented algorithms to accommodate these changes, fostering a flexible and agile computing framework.

Just-In-Time Programming may support rapid prototyping and iterative development. Users can experiment with different algorithms and automation strategies on the fly, testing their effectiveness and refining them iteratively. This iterative development process may allow for continuous improvement, reducing the time between idea conception and deployment.

Just-In-Time Programming may provide opportunity for immediate error detection and debugging. Since users are actively involved in the programming process, they can quickly identify and address issues as they arise, minimizing the impact on task completion.

For novice users, Just-in-Time Programming may offer a user-friendly and accessible entry point into programming. It may enable them to recognize algorithmic opportunities and implement computing solutions in real-time, without the need for extensive prior programming knowledge. By embracing Just-in-Time Programming, novices can leverage their domain expertise and insights gained during task execution to create software solutions tailored to their specific needs without being constrained by the limitations of pre-designed software.

For experienced programmers, Just-in-Time Programming may improve flexibility and agility to improve speed of prototyping, testing, and refining of algorithms during task execution. This real-time feedback loop allows programmers to fine-tune their code based on immediate results and user requirements, leading to more efficient and effective solutions. Additionally, experienced programmers can leverage Just-in-Time Programming to explore innovative approaches, as they have the capability to envision and implement complex algorithms on the fly.

Regardless of the user's programming expertise, Just-in-Time Programming empowers individuals to be actively involved in the development process, aligning it with their specific goals and requirements. By placing the user at the forefront, Just-in-Time Programming fosters a more inclusive computing environment, bridging the gap between users and developers. It encourages users to embrace their algorithmic insights, regardless of their programming background, and provides them with the tools and capabilities to transform these insights into functional and practical software solutions. Traditional programming approaches often require extensive upfront planning and design, which may not align with the dynamic nature of user tasks. With Just-in-Time Programming, users can implement algorithms during task execution, which may provide a close association between software functionality and immediate need. This approach may be particularly beneficial for novice users, as Just-in-Time Programming may provide a user-friendly entry point into programming. For experienced programmers, Just-in-Time Programming may offer a more interactive and dynamic programming experience. Just-in-Time Programming may give users a deeper understanding of their tasks and subtasks. By actively engaging with the programming process during task execution, users become more aware of the underlying algorithms and automation possibilities within their domain. This heightened understanding can lead to innovative solutions, as users are more likely to identify new approaches and optimize existing ones based on their firsthand experience.

Just-in-Time Programming may provide immediate error detection and debugging. Since users are actively involved in the programming process, they can quickly identify and address issues as they arise, minimizing the impact on task completion.

Just-In-Time Programming may be applicable in various sectors and industries, such as:
(a) Software Development: The Just-in-Time Programming framework streamlines the software development process by allowing developers to prototype, test, and refine algorithms in real time. This is particularly valuable in agile development environments where requirements are constantly evolving.
(b) Data Analysis and Machine Learning: The framework's ability to integrate with LLMs and other AI models may be well-suited for data analysis and machine learning tasks. Users can develop and implement complex algorithms for data processing, analysis, and model training in real time.
(c) Robotics and Automation: The Just-in-Time Programming framework can be used to develop algorithms for controlling robots and automated systems. Just-in-Time Programming may permit users to create and implement algorithms for navigation, object recognition, and manipulation, enabling more efficient and adaptable robotic systems.
(d) Internet of Things (IoT): Just-in-Time Programming may be useful for IoT applications where devices need to respond quickly to changing conditions. Just-in-Time Programming may permit users to develop and implement algorithms for data processing, decision making, and control in IoT environments.
(e) Financial Services: Just-in-Time Programming can be used in financial services for algorithmic trading, risk analysis, and fraud detection. Just-in-Time Programming may permit users to develop and implement algorithms for analyzing market data, predicting trends, and making real-time trading decisions.
(f) Healthcare: Just-in-Time Programming may be useful for developing algorithms for patient monitoring, medical imaging analysis, and drug discovery. Just-in-Time Programming may permit users to create and implement algorithms for processing medical data, diagnosing conditions, and optimizing treatment plans.
(g) Manufacturing: Just-in-Time Programming may be useful in manufacturing process optimization, quality control, and supply chain management. Just-in-Time Programming may permit users to develop and implement algorithms for monitoring production lines, detecting defects, and optimizing workflow.
(h) Education: Just-in-Time Programming may be useful in education for developing educational software, adaptive learning systems, and automated assessment tools. Just-in-Time Programming may permit users to create and implement algorithms for personalized learning experiences, student performance analysis, and content generation.

### II. EXAMPLES

### II.A. Example 1

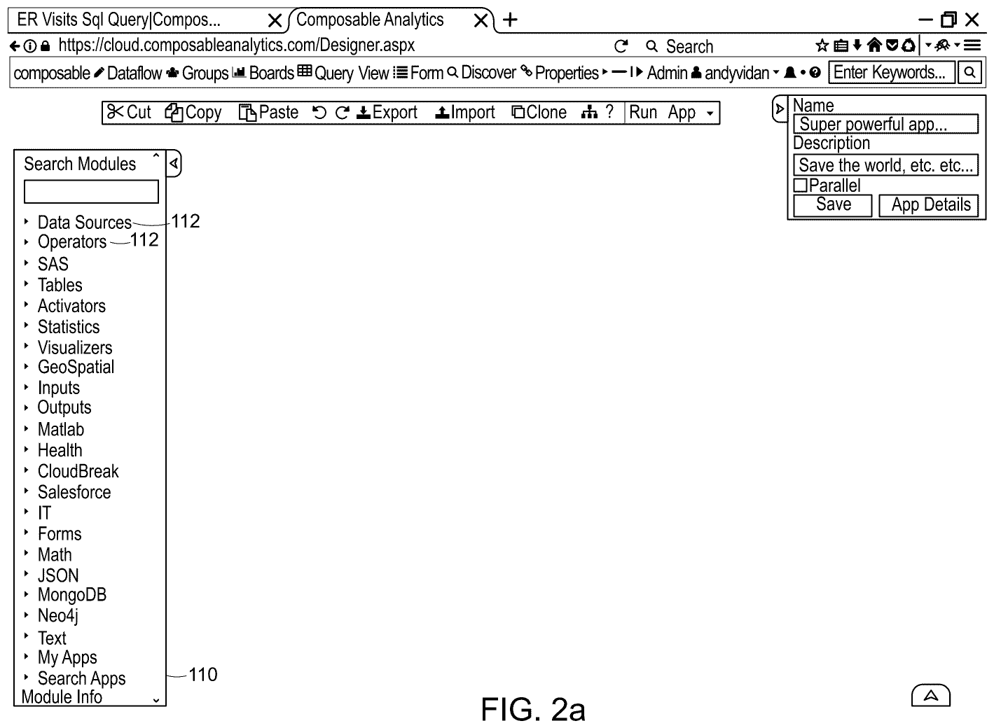

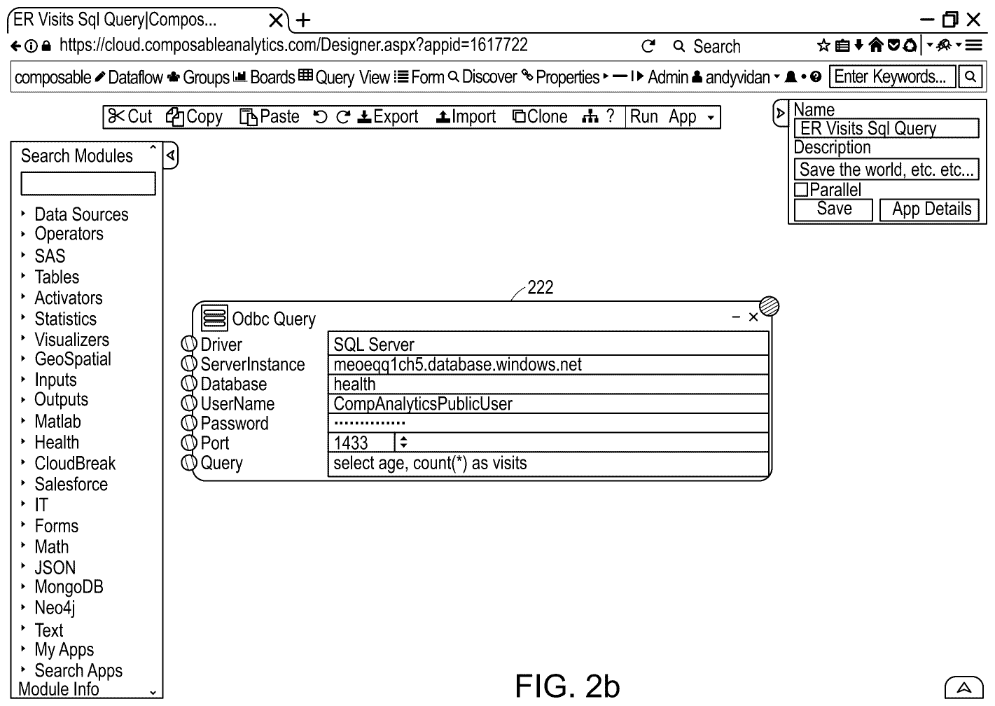

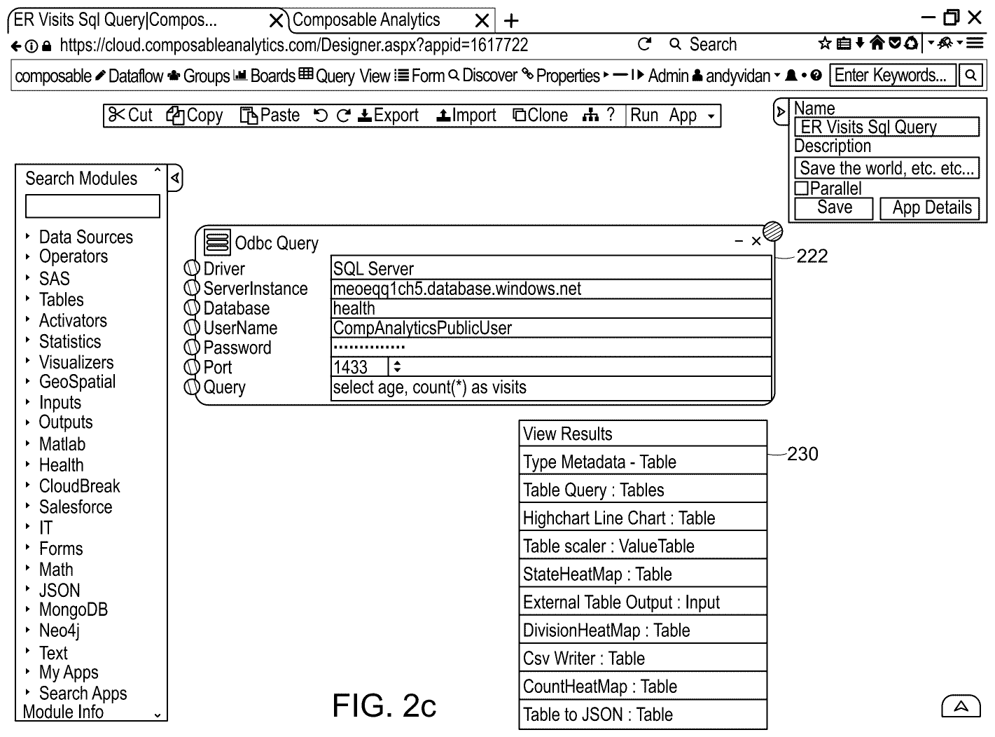

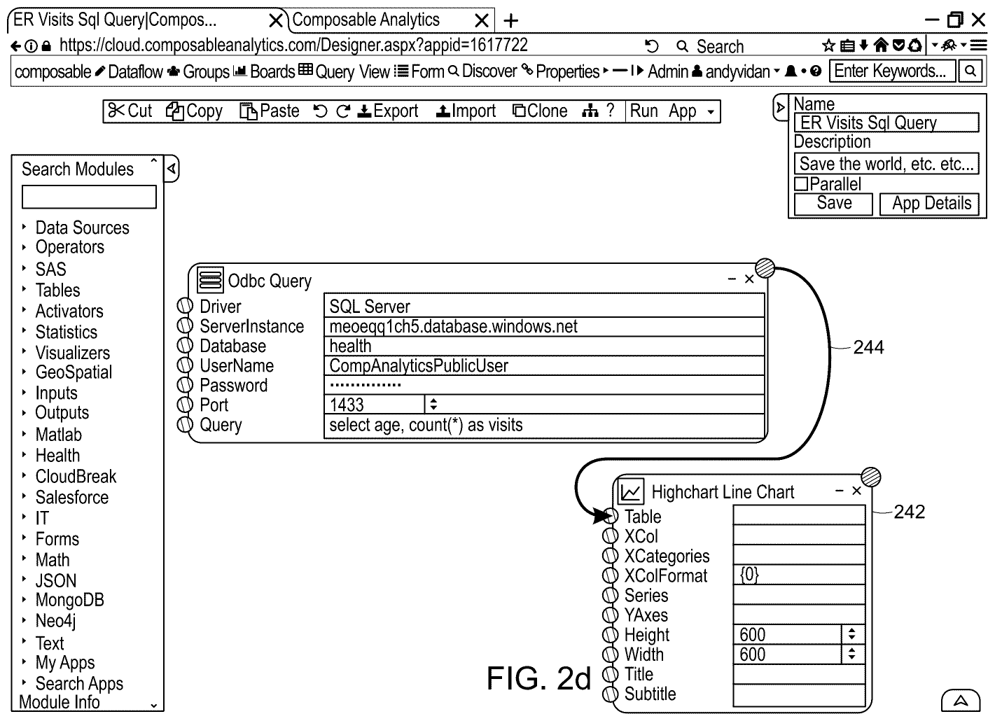

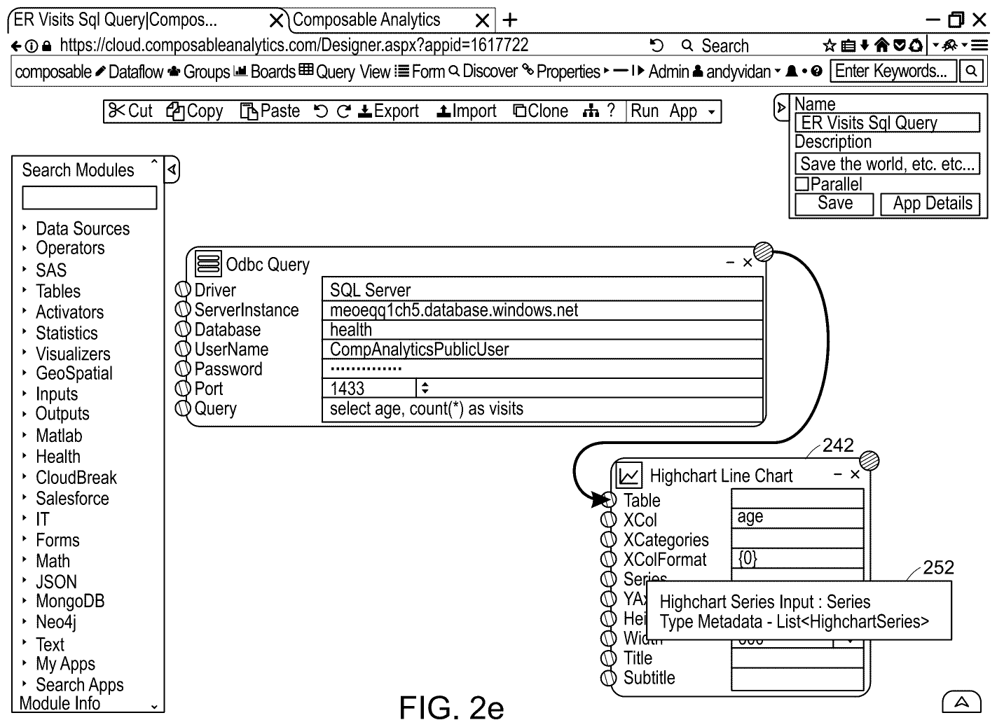

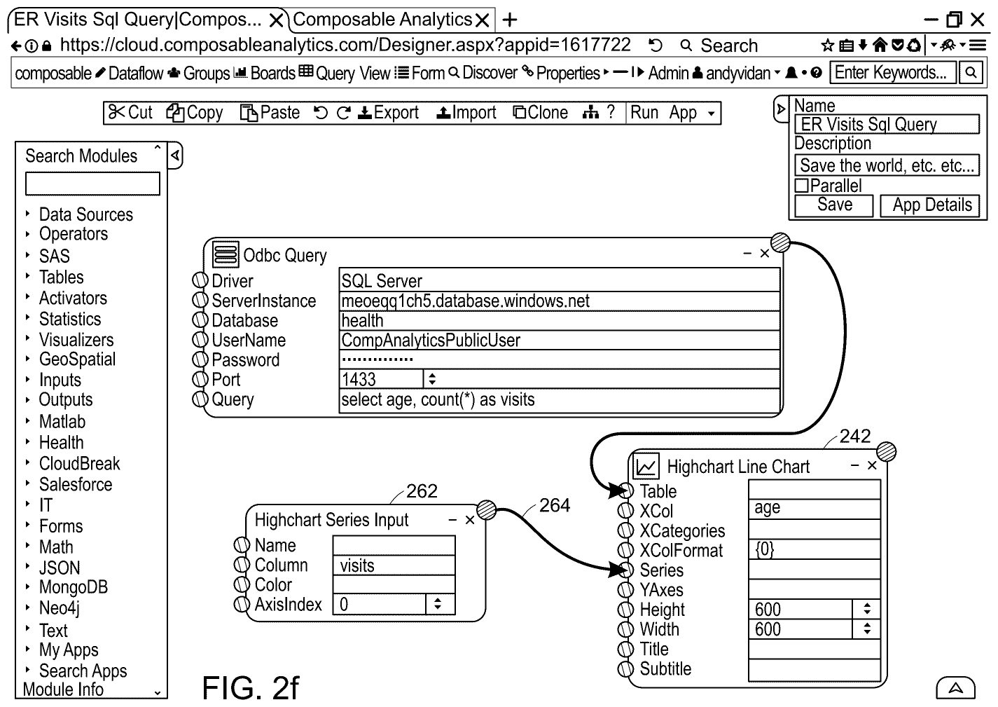

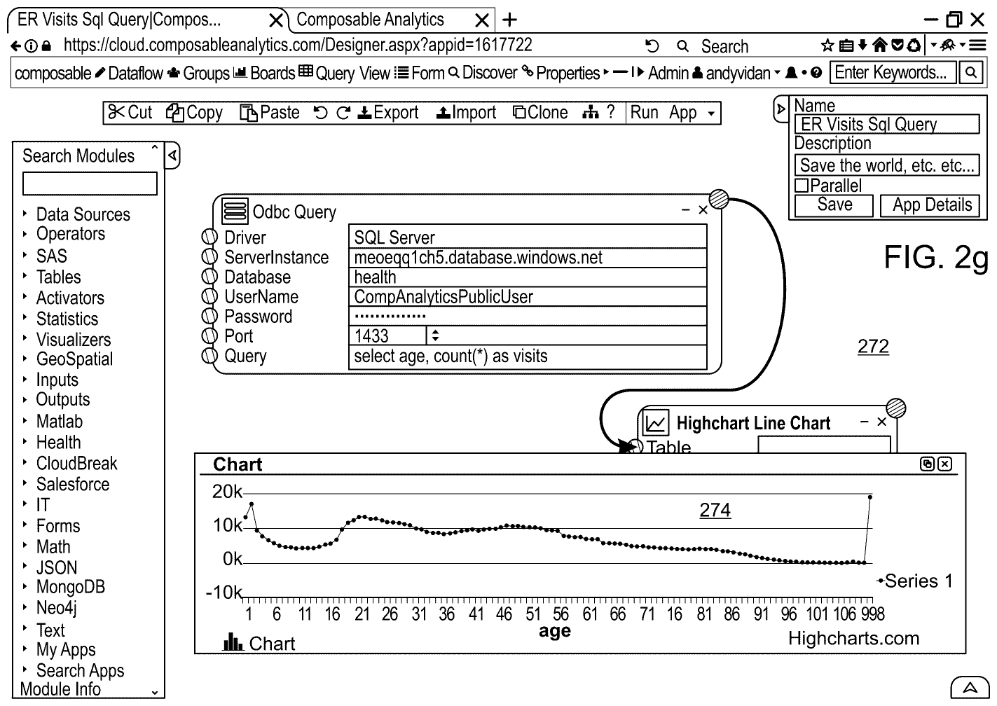

Referring to FIGS. 1a and 2a, a user may begin to create a new flow-based program with a “blank canvas.” A screen may show a library 110 or repository of available block templates 112, and a blank workspace waiting for the user to begin working. In a script-based system, the display may begin with an empty text file.

Repository 110 of block templates 112 may have many (tens, hundreds, or more than a thousand) block templates 112 that may be combined into a new flow-based program.

Referring to FIG. 2b, in the process of building a flow-based program, as the user begins to select each new block template 112 to instantiate a functional block into the flow-based program, AI assistant 102 uses available data 400 to automatically recommend one or more block templates 112, or connections from the output of one block to the input of another, that are highest probability to be of interest to the user, and offers them for selection. In the case of FIG. 2b, with a blank canvas, AI assistant 102 may not have enough information to offer a recommendation. Thus, this user may select a block template 112 without assistance. Alternatively, AI assistant 102 may predict that the user is most probable to begin with a Data Ingestion block, and may suggest a filtered list of block templates 112 to select. In the alternative, the user can issue a prompt to AI assistant 102 specifying a task to be performed, and AI assistant 102 may generate code to be plugged into the program under developed. In either event, in FIG. 2b, the user has selected “ODBC Database Query Functional block” 222 to ingest data from a database.

Referring to FIG. 2c, at this point, AI assistant 102 may provide recommendations on how to continue the build of the analytical workflow. In this case, because the first selection was “ODBC Database Query Functional block” 222 with a known output type of “Table”, AI assistant 102 recommends a set 230 of block templates 112 that most likely continues the flow-based program (e.g., functional blocks that take a table as input, and analyze, transform, or publish the table). Importantly, since the output of “ODBC Database Query Functional block” 222 is of type “Table,” AI assistant 102 infers that the highest-probability next block template 112 is chosen from among block templates 112 that have an input for an object of type “Table.” Based on data 400 collected from the user's past interactions and past interactions of other users (e.g., past programs that predominately dealt with similar ingested data—for example, from the same ODBC database, from social media feeds, environmental monitoring data, electoral demographic data, or whatever the user chose to begin with), AI assistant 102 may further refine its suggestion based on its understanding of that past activity to recommend data ingestion block templates 112 that ingest data from a specific source or with a specific structure (e.g., ingest social media content from Twitter). In FIG. 2c, from potentially hundreds of block templates 112 available in repository 110, AI assistant 102 may recommended a short list 230 of eleven block templates 112 and/or possible connections among existing functional blocks.

The user is not restricted to choosing from only the short list 230, but may select from the full palette 110 of available block templates 112, or menu 230 may have an “expand” entry (that might open up the recommendations to a second level), or a “break out” that presents the full palette.

Referring to FIG. 2d, from among the short list of recommendations 230, the user may select “Highchart Line Chart” 242 to create a line graph of the output (e.g., “publish”). The system may place a “Highchart Line Chart” block 242 on the user's screen. System 100 may then automatically connect 244 the table output of the ODBC block to the table input of the Highchart Line Chart functional block 242.

Referring to FIG. 2e, “Highchart Line Chart” functional block 242 has an input of data type “Series.” As the user fills out the input parameters to the new “Highchart Line Chart” functional block 242, AI assistant 102 may suggest 252 two possible inputs that might supply input of data type “Series” for one of the inputs to the “Highchart Line Chart” functional block.

Referring to FIG. 2f, when the user accepts the recommendation by selecting from short list menu 252, the programming system creates the selected functional block 262, and connects 264 the “Series” output of that new block to the “Series” input of Highchart Line Chart functional block 242.

Referring to FIG. 2g, the process of recommending actions, and the user accepting or rejecting the recommendations to continue building the program, continues across all phases until the user has completed building the full program 272. AI assistant 102 stores metadata describing the complete program and the process by which the user built it, in form useable for future recommendations.

The user may run the program, and the system will plot a chart 274 as its output.

### II.B. Example 2: Simple, Just-In-Time Arithmetic

As an initial simple Just-in-Time Programming example, we can use the following prompt:
Write a python function called gptFunction that adds two integers. only return the raw python code

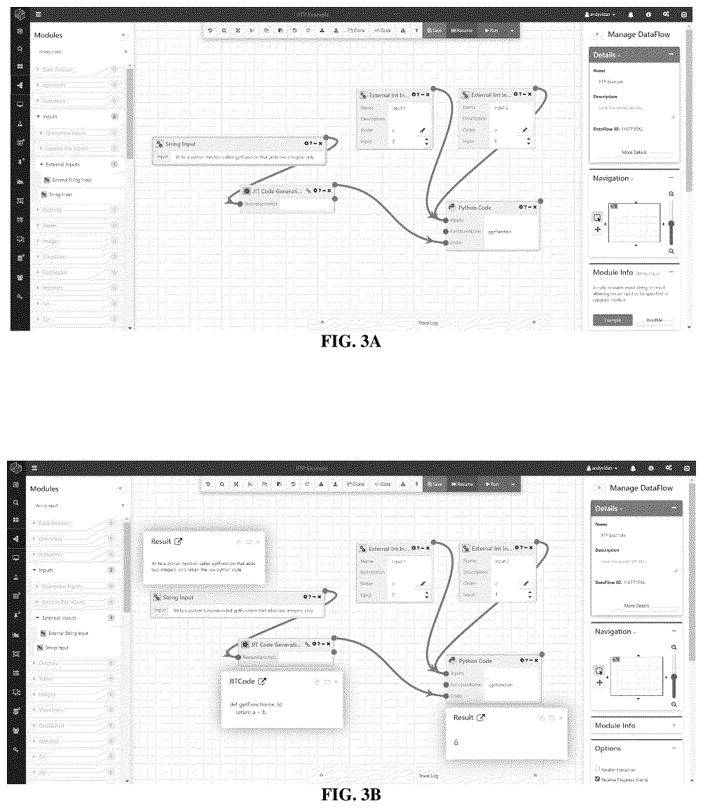

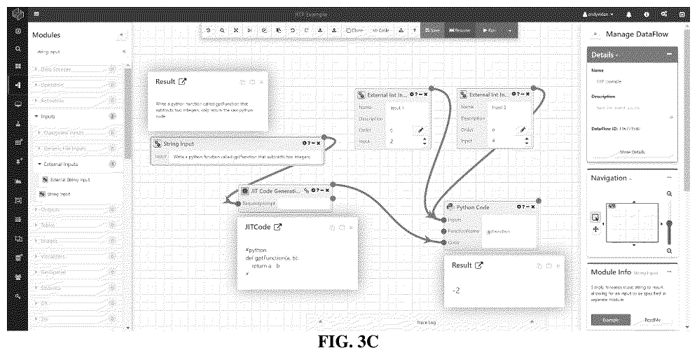

We can add a Python Code Module to the Flow-Based Program, as well as two integer inputs, as shown in FIG. 3A. FIG. 3A shows a simple Just-In-Time Programming Flow-Based Program that requests the addition of two integers. FIG. 3B shows the output of this Flow-Based Program. FIG. 3C shows the new output given the slightly altered prompt requesting subtraction rather than addition, showing the different code being generated just in time, based on the new request.

### II.C. Example 3: Primality Test

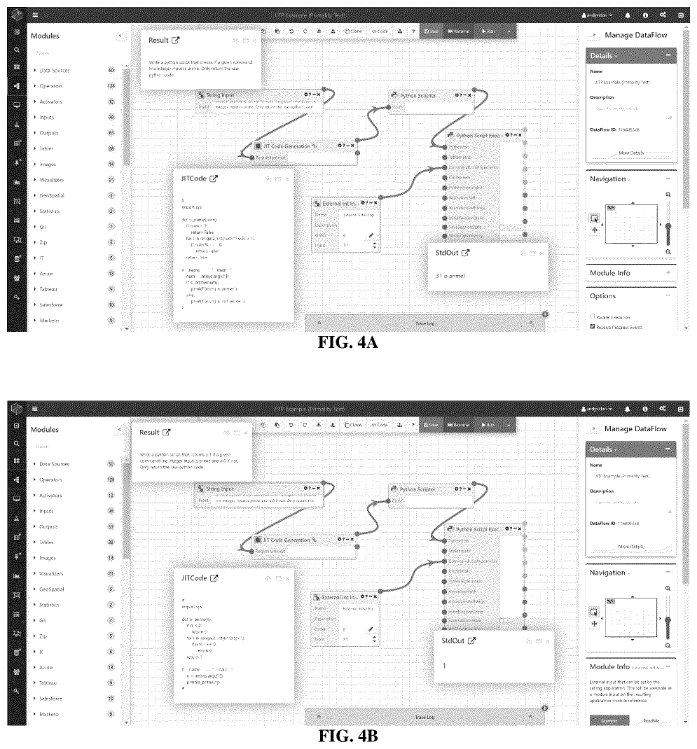

FIG. 4A shows a Flow-Based Program showing a Just-in-Time program to test whether an input integer is prime. In this example, we request a just-in-time algorithm for determining whether an input number is prime. Here, the Just-in-Time system is supplemented with a more generalized Python Scripter and Executor Modules that can generate and accept any Python script and any given number of inputs.

Here, our prompt is:
Write a python script that checks if a given command line integer input is prime. Only return the raw python code.

The “JIT Code Generation” Flow-Based Program returns the following Python script:

```
#
import sys
def is_prime(num):
  if num < 2:
    return False
  for i in range(2, int(num ** 0.5) + 1):
    if num % i == 0:
      return False
  return True
if _{——}name_{——}== “_{——}main_{——}”:
  num = int(sys.argv[1])
  if is_prime(num):
    print(f“{num} is prime!”)
  else:
    print(f“{num} is not prime.”)
#
```

And the result, for input 31 is, “31 is prime!”

This example, along with results, is shown in FIG. 4A.

This Flow-Based Program may be better integrated with other scripts if the Primality Test result is simply a Boolean (0 or 1). We can therefore simply adjust the input prompt:
Write a python script that returns a 1 if a given command line integer input is prime and a 0 if not. Only return the raw python code.

And we can see the updated Python Script is:

```
#
import sys
def is_prime(n):
  if n < 2:
    return 0
  for i in range(2, int(n ** 0.5)+1):
    if n % i == 0:
      return 0
  return 1
if _{——}name_{——} == “_{——}main_{——}”
  n = int(sys.argv[1])
  print(is_prime(n))
#
```

The full Flow-Based Program is shown in FIG. 4B, where the result is 1 for integer input 31 (and would be zero for a composite non-prime):

### II.D. Example 4: Generating New Data

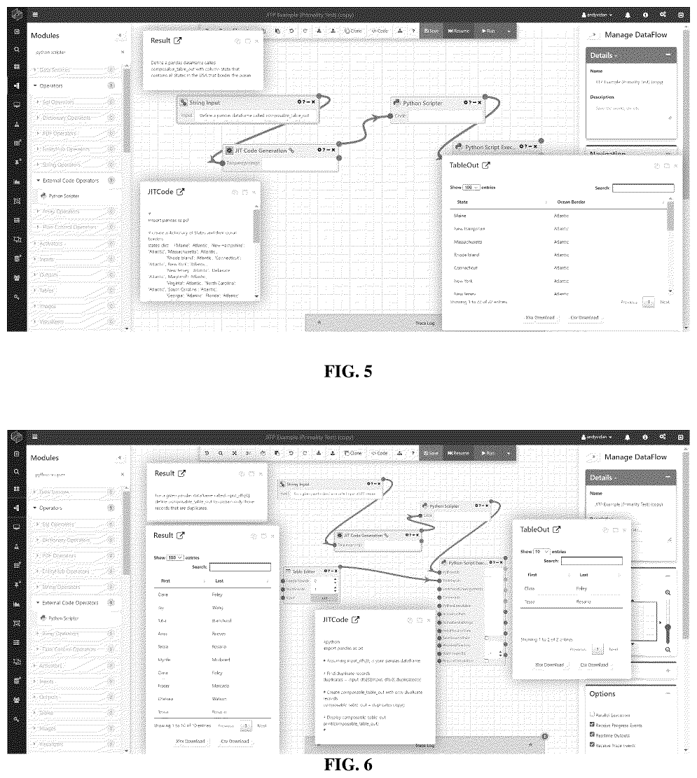

FIG. 5 shows an example, in which Just-in-Time Programming allows a user to generate a dataset. Here, we use as our prompt:
Define a pandas dataframe called composable_table_out with column State that contains all States in the USA that border the ocean.

The “JIT Code Generation” Flow-Based Program returns the following Python script:

```
#
import pandas as pd
# create a dictionary of States and their ocean borders
states_dict = {‘Maine’: ‘Atlantic’, ‘New Hampshire’: ‘Atlantic’,
‘Massachusetts': ‘Atlantic’,
  ‘Rhode Island’: ‘Atlantic’, ‘Connecticut’: ‘Atlantic’,
‘New York’: ‘Atlantic’,
  ‘New Jersey’: ‘Atlantic’, ‘Delaware’: ‘Atlantic’,
‘Maryland’: ‘Atlantic’,
  ‘Virginia’: ‘Atlantic’, ‘North Carolina’: ‘Atlantic’,
‘South Carolina’: ‘Atlantic’,
  ‘Georgia’: ‘Atlantic’, ‘Florida’: ‘Atlantic’, ‘Texas’: ‘Gulf
of Mexico’,
  ‘Louisiana’: ‘Gulf of Mexico’, ‘Mississippi’: ‘Gulf of
Mexico’, ‘Alabama’: ‘Gulf of Mexico’,
  ‘California’: ‘Pacific’, ‘Oregon’: ‘Pacific’,
‘Washington’: ‘Pacific’, ‘Alaska’: ‘Pacific’}
# create a pandas dataframe from the dictionary
composable_table_out =
pd.DataFrame(list(states_dict.items( )), columns=[‘State’,
‘Ocean Border’])
# filter the dataframe to only include States that border the
ocean
composable_table_out =
composable_table_out[composable_table_out[‘Ocean
Border’].notnull( )]
# display the dataframe
print(composable_table_out)
#
```

The table output is shown in FIG. 5.

### II.E. Example 5: Table Manipulation

More complex data processing workflows generally require the manipulation of tables. FIG. 6 shows an example request to select only records that appear more than once in an input table. Our prompt is:
For a given pandas dataframe called input_dfs [0], define composable_table_out to contain only those records that are duplicates.

The generated Python is:

#python
import pandas as pd
# Assuming input_dfs[0] is your pandas dataframe
# Find duplicate records
duplicates = input_dfs[0][input_dfs[0].duplicated( )]
# Create composable_table_out with only duplicate records
composable_table_out = duplicates.copy( )
# Display composable_table_out
print(composable_table_out)
#

### II.F. EXAMPLE 6: ADDING TWO INTEGER INPUTS

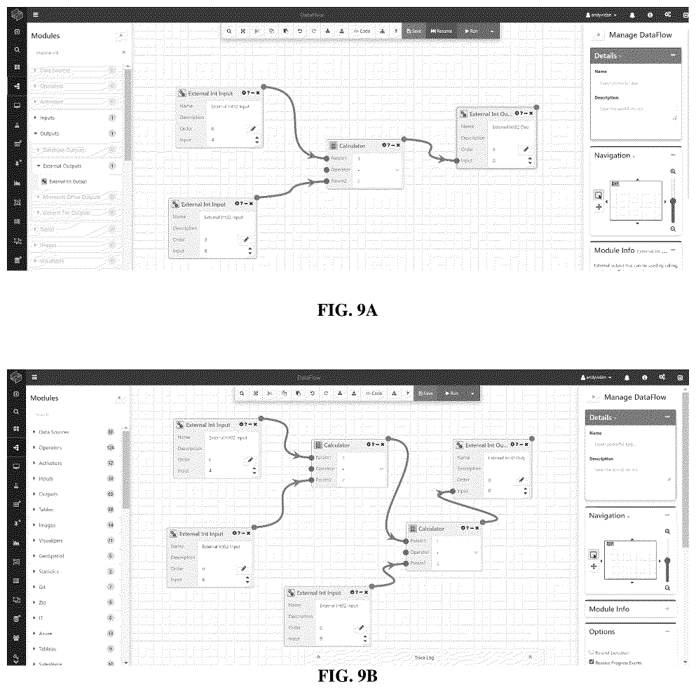

FIG. 9A shows an example, a simple Flow-Based Program that takes two integer inputs, performs an arithmetic computation (addition, subtraction, . . . ) and returns that arithmetic result. This program is built as follows:
1. Two External Int Input Modules are used for the integer inputs
2. A Calculator Module to perform the arithmetic computation (e.g., addition)
3. An External Int Output Module for the external integer output.

We are able to convert this visual flow-based program into structured source code (e.g., in C#). The Flow-Based Program shown in FIG. 9A can therefore be represented as:

```
//------------------------------------------------------------------------------
// Fluent Flow Code for the Composable DataOps Platform.
// Database Version: 1.0.339.0
// Assembly Version: 2.0.20885.0
// Composable Build Date: May 11, 2023 10:55:31 AM
// Code Generated Date: June 27, 2023 10:49:25 PM
//------------------------------------------------------------------------------
using CompAnalytics.Contracts;
using CompAnalytics.FluentAPI;
using System;
public class Program
{
  private static
CompAnalytics.IServices.Deploy.ResourceManager
CreateManager( )
  {
    CompAnalytics.IServices.Deploy.ConnectionSettings
connectionSettings = new
CompAnalytics.IServices.Deploy.ConnectionSettings( );
    connectionSettings.Uri = new
System.Uri(“https://cloud.composableanalytics.com/”);
    connectionSettings.AuthMode =
CompAnalytics.IServices.Deploy.AuthMode.Form;
    connectionSettings.FormCredential = new
System.Net.NetworkCredential(“andyvidan”, “*****”);
    CompAnalytics.IServices.Deploy.ResourceManager
mgr = new
CompAnalytics.IServices.Deploy.ResourceManager(connect
ionSettings);
    return mgr;
  }
  private static CompAnalytics.Contracts.Application
CreateDataFlow(CompAnalytics.IServices.IApplicationServic
eClient client)
  {
    CompAnalytics.Contracts.Application app = new
CompAnalytics.Contracts.Application( );
    app.Name = “”;
    app.Description = “”;
    app.ReceiveProgressEvents = true;
    app.ReceiveProgressEvents = true;
    app.ShowRealTimeOutputs = true;
    app.ReceiveTraceEvents = true;
ModuleBuilder<CompAnalytics.Execution.ExternalIntInputEx
ecutor> module0 =
ModuleBuilder.Create<CompAnalytics.Execution.ExternalIntI
nputExecutor>( )
          .SetName(“External Int Input”)
          .AtLocation(368D, 159D, 207D)
          .ConfigureInput(m =>
m.Name).WithValue(“External Int32 Input”)
          .ConfigureInput(m =>
m.Description).WithValue(null)
          .ConfigureInput(m =>
m.Order).WithValue(0)
          .ConfigureInput(m =>
m.Input).WithValue(4)
          .SetRequestingExecutionTo(true)
          .AddToApp(app);
ModuleBuilder<CompAnalytics.Execution.ExternalIntInputEx
ecutor> module1 =
ModuleBuilder.Create<CompAnalytics.Execution.ExternalIntI
nputExecutor>( )
          .SetName(“External Int Input”)
          .AtLocation(351D, 434D, 207D)
          .ConfigureInput(m =>
m.Name).WithValue(“External Int32 Input”)
          .ConfigureInput(m =>
m.Description).WithValue(null)
          .ConfigureInput(m =>
m.Order).WithValue(0)
          .ConfigureInput(m =>
m.Input).WithValue(6)
          .SetRequestingExecutionTo(true)
          .AddToApp(app);
ModuleBuilder<CompAnalytics.Execution.Modules.Calculato
rModuleExecutor> module2 =
ModuleBuilder.Create<CompAnalytics.Execution.Modules.C
alculatorModuleExecutor>( )
          .SetName(“Calculator”)
          .AtLocation(743D, 289D, 180D)
          .ConfigureInput(m =>
m.Param1).WithConnection(module0.SelectOutput(c =>
c.Result))
          .ConfigureInput(m =>
m.Operator).WithValue(“+”)
          .ConfigureInput(m =>
m.Param2).WithConnection(module1.SelectOutput(c =>
c.Result))
          .SetRequestingExecutionTo(true)
          .AddToApp(app);
ModuleBuilder.Create<CompAnalytics.Execution.ExternalInt
OutputExecutor>( )
          .SetName(“External Int Output”)
          .AtLocation(1066D, 210D,
186.465D)
          .ConfigureInput(m =>
m.Name).WithValue(“External Int32 Output”)
          .ConfigureInput(m =>
m.Description).WithValue(null)
          .ConfigureInput(m =>
m.Order).WithValue(0)
          .ConfigureInput(m =>
m.Input).WithConnection(module2.SelectOutput(c =>
c.Result))
          .SetRequestingExecutionTo(true)
          .AddToApp(app);
    return app;
  }
  private static CompAnalytics.Contracts.Application
RunDataFlow( )
  {
    CompAnalytics.IServices.Deploy.ResourceManager
mgr = Program.CreateManager( );
    try
    {
      CompAnalytics.IServices.IApplicationServiceClient
client =
mgr.CreateAuthChannel<CompAnalytics.IServices.IApplicati
onServiceClient>(“ApplicationService”);
      CompAnalytics.Contracts.Application app =
Program.CreateDataFlow(client);
      CompAnalytics.Contracts.ExecutionHandle handle =
client.CreateExecutionContext(app,
ExecutionContextOptions.None);
      CompAnalytics.Contracts.Application results =
client.RunExecutionContext(handle);
      return results;
    }
    finally
    {
      mgr.Dispose( );
    }
  }
  private static void LoadAssemblies( )
  {
System.Reflection.Assembly.Load(“CompAnalytics.Contract
s, Version=1.0.0.0, Culture=neutral,
PublicKeyToken=792cfbd” +
        “70dcd13a9”);
System.Reflection.Assembly.Load(“CompAnalytics.Core,
Version=1.0.0.0, Culture=neutral,
PublicKeyToken=792cfbd70dcd” +
        “13a9”);
System.Reflection.Assembly.Load(“CompAnalytics.Executio
n, Version=1.0.0.0, Culture=neutral,
PublicKeyToken=792cfbd” +
        “70dcd13a9”);
System.Reflection.Assembly.Load(“CompAnalytics.Executio
n.Modules, Version=1.0.0.0, Culture=neutral,
PublicKeyToken” +
        “=792cfbd70dcd13a9”);
System.Reflection.Assembly.Load(“CompAnalytics.Extensio
n, Version=1.0.0.0, Culture=neutral,
PublicKeyToken=792cfbd” +
        “70dcd13a9”);
System.Reflection.Assembly.Load(“CompAnalytics.FluentAP
I, Version=1.0.0.0, Culture=neutral,
PublicKeyToken=792cfbd” +
        “70dcd13a9”);
System.Reflection.Assembly.Load(“CompAnalytics.IServices
, Version=1.0.0.0, Culture=neutral,
PublicKeyToken=792cfbd” +
        “70dcd13a9”);
System.Reflection.Assembly.Load(“CompAnalytics.Utils,
Version=1.0.0.0, Culture=neutral,
PublicKeyToken=792cfbd70dc” +
        “d13a9”);
  }
  public static int Main(string[ ] argv)
  {
    Program.LoadAssemblies( );
    Program.RunDataFlow( );
    return 0;
  }
}
```

The generated code may leverage FluentAPI, a set of C#classes developed by Composable Analytics of Cambridge MA, that interact with other services by Composable Analytics.

This is enabled by some of the key characteristics of Flow-Based Programming. Specifically:
Strongly Typed Modules: Flow-Based Programming paradigm may enforce strong typing of Modules, ensuring that data types are explicitly defined and consistent throughout the Flow-Based Program. This helps catch errors at compile-time and promotes safer and more reliable software development.
Loose Coupling: The Flow-Based Programming paradigm may promote loose coupling between Modules, meaning that Modules are decoupled from each other and communicate through well-defined data interfaces.

### II.G. Example 7: A Calculator

As an example, the Flow-Based Program in FIG. 9A may be given the following prompt:
Generate a program that takes 2 External Integer Inputs, feeds them into a Calculator Module for addition, then feeds it into another Calculator Module along with a third External Integer Inputs for addition, and returns an External Integer Output.

The output is:

```
//------------------------------------------------------------------------------
using CompAnalytics.Contracts;
using CompAnalytics.FluentAPI;
using System;
public class Program
{
  private static
CompAnalytics.IServices.Deploy.ResourceManager
CreateManager( )
  {
    CompAnalytics.IServices.Deploy.ConnectionSettings
connectionSettings = new
CompAnalytics.IServices.Deploy.ConnectionSettings( );
    connectionSettings.Uri = new
System.Uri(“https://cloud.composableanalytics.com/”);
    connectionSettings.AuthMode =
CompAnalytics.IServices.Deploy.AuthMode.Form;
    connectionSettings.FormCredential = new
System.Net.NetworkCredential(“andyvidan”, “*****”);
    CompAnalytics.IServices.Deploy.ResourceManager
mgr = new
CompAnalytics.IServices.Deploy.ResourceManager(connect
ionSettings);
    return mgr;
  }
  private static CompAnalytics.Contracts.Application
CreateDataFlow(CompAnalytics.IServices.IApplicationServic
eClient client)
  {
    CompAnalytics.Contracts.Application app = new
CompAnalytics.Contracts.Application( );
    app.Name = “”;
    app.Description = “”;
    app.ReceiveProgressEvents = true;
    app.ReceiveProgressEvents = true;
    app.ShowRealTimeOutputs = true;
    app.ReceiveTraceEvents = true;
ModuleBuilder<CompAnalytics.Execution.ExternalIntInputEx
ecutor> module0 =
ModuleBuilder.Create<CompAnalytics.Execution.ExternalIntI
nputExecutor>( )
      .SetName(“External Int Input”)
      .AtLocation(368D, 159D, 207D)
      .ConfigureInput(m => m.Name).WithValue(“External
Int32 Input”)
      .ConfigureInput(m => m.Description).WithValue(null)
      .ConfigureInput(m => m.Order).WithValue(0)
      .ConfigureInput(m => m.Input).WithValue(4)
      .SetRequestingExecutionTo(true)
      .AddToApp(app);
ModuleBuilder<CompAnalytics.Execution.ExternalIntInputEx
ecutor> module1 =
ModuleBuilder.Create<CompAnalytics.Execution.ExternalIntI
nputExecutor>( )
      .SetName(“External Int Input”)
      .AtLocation(351D, 434D, 207D)
      .ConfigureInput(m => m.Name).WithValue(“External
Int32 Input”)
      .ConfigureInput(m => m.Description).WithValue(null)
      .ConfigureInput(m => m.Order).WithValue(0)
      .ConfigureInput(m => m.Input).WithValue(6)
      .SetRequestingExecutionTo(true)
      .AddToApp(app);
ModuleBuilder<CompAnalytics.Execution.Modules.Calculato
rModuleExecutor> module2 =
ModuleBuilder.Create<CompAnalytics.Execution.Modules.C
alculatorModuleExecutor>( )
      .SetName(“Calculator 1”)
      .AtLocation(713D, 210D, 180D)
      .ConfigureInput(m =>
m.Param1).WithConnection(module0.SelectOutput(c =>
c.Result))
      .ConfigureInput(m => m.Operator).WithValue(“+”)
      .ConfigureInput(m =>
m.Param2).WithConnection(module1.SelectOutput(c =>
c.Result))
      .SetRequestingExecutionTo(true)
      .AddToApp(app);
ModuleBuilder<CompAnalytics.Execution.ExternalIntInputEx
ecutor> module3 =
ModuleBuilder.Create<CompAnalytics.Execution.ExternalIntI
nputExecutor>( )
      .SetName(“External Int Input”)
      .AtLocation(351D, 614D, 207D)
      .ConfigureInput(m => m.Name).WithValue(“External
Int32 Input”)
      .ConfigureInput(m => m.Description).WithValue(null)
      .ConfigureInput(m => m.Order).WithValue(0)
      .ConfigureInput(m => m.Input).WithValue(8)
      .SetRequestingExecutionTo(true)
      .AddToApp(app);
ModuleBuilder<CompAnalytics.Execution.Modules.Calculato
rModuleExecutor> module4 =
ModuleBuilder.Create<CompAnalytics.Execution.Modules.C
alculatorModuleExecutor>( )
      .SetName(“Calculator 2”)
      .AtLocation(967D, 210D, 180D)
      .ConfigureInput(m =>
m.Param1).WithConnection(module2.SelectOutput(c =>
c.Result))
      .ConfigureInput(m => m.Operator).WithValue(“+”)
      .ConfigureInput(m =>
m.Param2).WithConnection(module3.SelectOutput(c =>
c.Result))
      .SetRequestingExecutionTo(true)
      .AddToApp(app);
ModuleBuilder.Create<CompAnalytics.Execution.ExternalInt
OutputExecutor>( )
      .SetName(“External Int Output”)
      .AtLocation(1306D, 210D, 186.465D)
      .ConfigureInput(m => m.Name).WithValue(“External
Int32 Output”)
      .ConfigureInput(m => m.Description).WithValue(null)
      .ConfigureInput(m => m.Order).WithValue(0)
      .ConfigureInput(m =>
m.Input).WithConnection(module4.SelectOutput(c =>
c.Result))
      .SetRequestingExecutionTo(true)
      .AddToApp(app);
    return app;
  }
  private static CompAnalytics.Contracts.Application
RunDataFlow( )
  {
    CompAnalytics.IServices.Deploy.ResourceManager
mgr = Program.CreateManager( );
    try
    {
      CompAnalytics.IServices.IApplicationServiceClient
client =
mgr.CreateAuthChannel<CompAnalytics.IServices.IApplicati
onServiceClient>(“ApplicationService”);
      CompAnalytics.Contracts.Application app =
Program.CreateDataFlow(client);
      CompAnalytics.Contracts.ExecutionHandle handle =
client.CreateExecutionContext(app,
ExecutionContextOptions.None);
      CompAnalytics.Contracts.Application results =
client.RunExecutionContext(handle);
      return results;
    }
    finally
    {
      mgr.Dispose( );
    }
  }
  private static void LoadAssemblies( )
  {
System.Reflection.Assembly.Load(“CompAnalytics.Contract
s, Version=1.0.0.0, Culture=neutral,
PublicKeyToken=792cfbd” + “70dcd13a9”);
System.Reflection.Assembly.Load(“CompAnalytics.Core,
Version=1.0.0.0, Culture=neutral,
PublicKeyToken=792cfbd70dcd” + “13a9”);
System.Reflection.Assembly.Load(“CompAnalytics.Executio
n, Version=1.0.0.0, Culture=neutral,
PublicKeyToken=792cfbd” + “70dcd13a9”);
System.Reflection.Assembly.Load(“CompAnalytics.Executio
n.Modules, Version=1.0.0.0, Culture=neutral,
PublicKeyToken” + “=792cfbd70dcd13a9”);
System.Reflection.Assembly.Load(“CompAnalytics.Extensio
n, Version=1.0.0.0, Culture=neutral,
PublicKeyToken=792cfbd” + “70dcd13a9”);
System.Reflection.Assembly.Load(“CompAnalytics.FluentAP
I, Version=1.0.0.0, Culture=neutral,
PublicKeyToken=792cfbd” + “70dcd13a9”);
System.Reflection.Assembly.Load(“CompAnalytics.IServices
, Version=1.0.0.0, Culture=neutral,
PublicKeyToken=792cfbd” + “70dcd13a9”);
System.Reflection.Assembly.Load(“CompAnalytics.Utils,
Version=1.0.0.0, Culture=neutral,
PublicKeyToken=792cfbd70dc” + “d13a9”);
  }
  public static int Main(string[ ] argv)
  {
    Program.LoadAssemblies( );
    Program.RunDataFlow( );
    return 0;
  }
}
```

Visually, a flow-based program generated by a purpose-built LLM based on the prompt given in ¶[0069] is shown as a Flow-Based Program in FIG. 9B.

To summarize, a powerful Just-In-Time Computing Framework may use trained LLM combined with a Flow-Based Programming model, may work as follows:
1. End-user (non-technical or technical user) defines a flow-based execution structure (Flow-Based Program) utilizing pre-built components (functional blocks or Modules)
2. As part of the Flow-Based Program, end-user inserts one or more prompts for specific tasks or subtasks to be completed
3. Purpose-built LLM generates a Flow-Based Program for each prompt
4. Flow-Based Programs are visually represented (and available for inspection even by a non-technical user)
5. Child Flow-Based Programs are executed according to the defined Flow-Based Program

### III. Application of Large Language Model Technology to Flow-Based Programming

### III.A. Large Language Models

Large Language Models (LLMs) are advanced artificial intelligence (AI) models designed to understand and generate human language. LLMs can also be extensively trained on diverse code repositories and documentation, so that the models acquire an understanding of programming syntax, structures, and patterns. LLMs can therefore generate software code by leveraging their language processing capabilities and knowledge of programming concepts. When tasked with generating software code, LLMs can take high-level instructions or prompts provided by users and generate corresponding code snippets or even complete programs. They can analyze the context, infer the desired functionality, and generate code that aligns with the specified requirements.

Integrating Large Language Models (LLMs) with Flow-Based Programming can create a powerful framework for Just-in-Time Programming, combining the capabilities of advanced language models with the modular and reactive workflow of Flow-Based Programming. LLMs leverage their language understanding and code generation capabilities to enable users to express their algorithmic insights and automate tasks in real time. Flow-based programming, with its visual representation of tasks and data flow, provides the overall structured approach by facilitating the incorporation of dynamically generated code into the overall execution workflow. Here, we outline the steps involved in integrating LLMs with Flow-Based Programming to develop an effective Just-in-Time Programming framework.
1. Identify Task-Specific LLMs: Begin by identifying the LLMs that are most relevant to the specific task domain. Select LLMs that align with the programming language or task requirements to enhance the Just-in-Time Programming capabilities. (See § III.C.6 below.)
2. Define LLM Components: Next, define LLM components within the Flow-Based Programming framework. These components encapsulate the interactions with LLMs, such as sending input text, retrieving generated code or responses, and managing the LLM state. Design the components to encapsulate the complexity of interacting with the LLMs and provide a simple interface for other components to utilize.
3. Establish Data Flow: Design the data flow between the LLM components and other components within the Flow-Based Programming framework. Determine the input data required by the LLM component, such as task descriptions, code snippets, or user instructions. Define the outputs from the LLM components, such as generated code, text responses, or relevant suggestions.
4. Enable Reactive Execution: Leverage the reactive execution model of Flow-Based Programming to trigger LLM interactions based on incoming data or events. For example, when a user provides a task description or requests assistance, the relevant LLM component can be triggered to generate code or provide suggestions.
5. Handle LLM State Management: LLMs often have a limited context window, meaning they may not have full access to the entire task history. To overcome this limitation, consider incorporating mechanisms to manage the state of the LLMs. This can involve maintaining a context buffer or session management to provide relevant contextual information to the LLM component during task execution.
6. Visualize and Debug LLM Interactions: Utilize visualization and debugging tools provided by the Flow-Based Programming framework to monitor the interactions with LLM components. This enables users to understand the flow of data, identify potential bottlenecks, and troubleshoot any issues related to LLM interactions. Visualization tools can also aid in interpreting LLM-generated outputs and provide feedback to assess alignment between inputs and desired outcomes.
7. Iterate and Improve: Continuously iterate on the LLM integration within the Just-in-Time Programming framework based on user feedback, task requirements, and performance evaluation. Refine the LLM components, data flow, and reactive execution to optimize the Just-in-Time Programming experience. Incorporate user preferences and algorithmic insights gained during task execution to further enhance the efficiency and effectiveness of the Just-in-Time Programming framework.

By integrating LLMs with Flow-Based Programming, developers can leverage the language modeling capabilities of LLMs within the Just-in-Time Programming framework, enabling users to generate code, receive suggestions, or obtain relevant information in real-time. This integration combines the strengths of advanced language models with the modularity, scalability, and adaptability of Flow-Based Programming, resulting in a powerful Just-in-Time Programming framework capable of supporting a wide range of tasks and domains.

### III.B. Just-in-Time Programming Platform

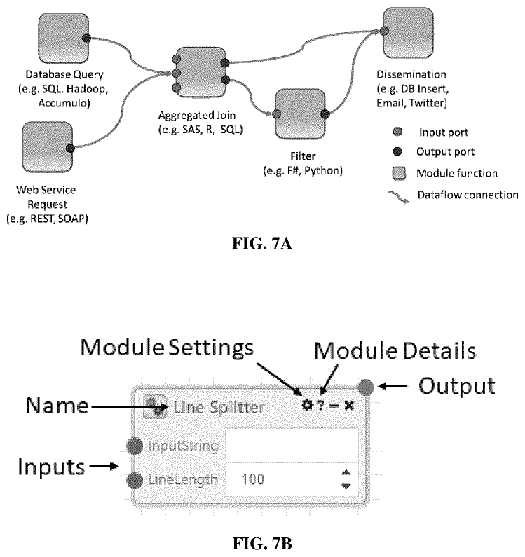

Referring to FIG. 7A, flow-based programs may be represented as event-driven workflows and may be authored using an intuitive, visual flow-based programming method. Each flow-based program has functional blocks, here called Modules, that are connected together to produce higher-level functionality. Modules are processing elements that may have strongly typed inputs and outputs. Information required for a Module to execute is retrieved from its inputs through connections, and global data. Modules can be reused easily and interchanged with other Modules. FIG. 7A shows a program that receives input from two sources, aggregates the two sources to join them, applies a filter, and generates some form of output for storage or dissemination.

As shown in FIG. 7B, a Module takes in zero or more inputs, and produces one or many outputs. These outputs can then be connected to any number of other Module inputs.

End-users can compose unique flow-based programming applications by dragging and dropping Modules and connecting them together in a modular design.

Modules that execute LLM computations can be created. In this article, we demonstrate the use of OpenAI's GPT-3 as the back-end LLM for the Just-in-Time Programming framework. While OpenAI's GPT-3 is primarily trained on vast amounts of text data and excels at natural language understanding and generation, and other LLMs may be better suited for software code generation. A Just-In-Time Analytic system may be built around OpenAI's GPT-3, with its simple API interface, another general-purpose LLM, or purpose-built LLMs.

### III.C. Just-in-Time Programming Demonstration

### III.C.1. JIT Code Generation Module

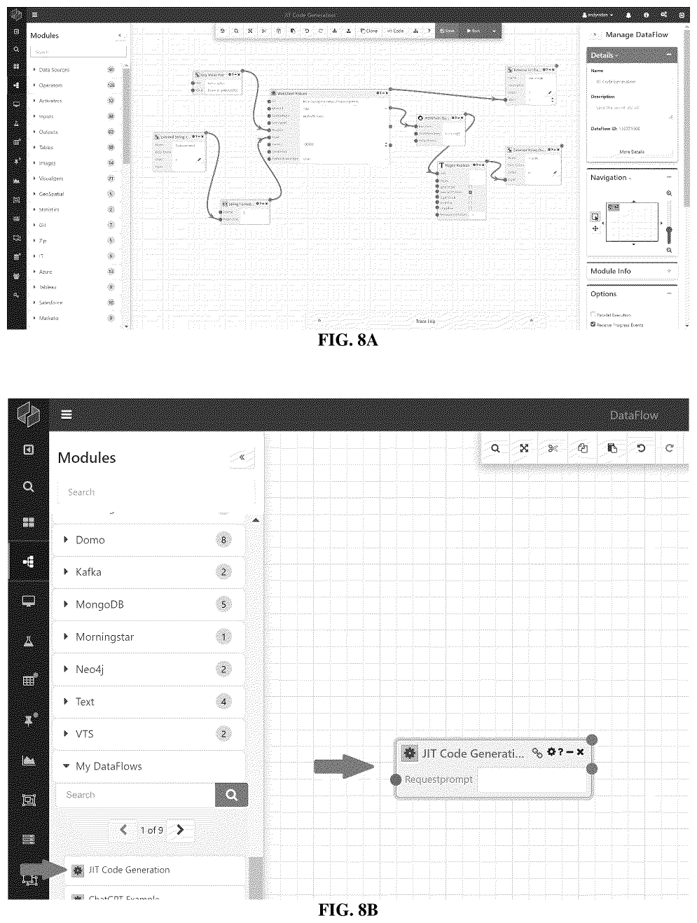

Referring to FIG. 8A, an example “JIT Code Generation” Flow-Based Program may serve as an “App Reference” Module (a Module that calls another Flow-Based Program) within our execution Flow-Based Program. The “JIT Code Generation” Flow-Based Program, shown in FIG. 8A has a WebClient Robust Module that accepts a single string input as a prompt, makes a request against the ChatGPT API, and returns the response.

The WebClient Robust Module uses the following parameters:
Uri: https://api.openai.com/v1/chat/completions.
Method: POST
Content-Type: application/json
Header: We use a Key Value Pair Module with Key “Authorization” and Value “Bearer <your_API_secret_key>”
Input: Here, we simply use an External String Input Module, so that we can externalize the input to other Flow-Based Programs. We pass this to a String Formatter Module, so we can place the end-user prompt with the syntactically correct json request payload:

```
{
  “model”: “gpt-3.5-turbo”,
  “messages”: [{“role”: “user”, “content”: “<end-user prompt>”}],
  “temperature”: 0.7
}
```

We externalize two outputs:
a. Status code of the web request (e.g., 200)
b. String output, after first extracting the json value using the JSONPath Query Module, followed by a Regex Replace Module. We use the Regex Replace Module because ChatGPT usually returns code proceeded with backticks (′), that we use to parse out the
   actual raw text and extraneous natural language within the response.

The complete “JIT Code Generation” Flow-Based Program is shown in FIG. 8A.

We can use the “JIT Code Generation” Flow-Based Program as an “App Reference” Module (a Module that calls another Flow-Based Program application) within our main execution Flow-Based Program. One of the powerful features of a Flow-Based Programming framework is that Flow-Based Programs can be used within Flow-Based Programs. FIG. 8B shows how we can find a newly created Flow-Based Program in the Module Palette, and simply drag and drop it onto the Designer canvas. The App Reference Module shows the single externalized input for the request prompt and the two externalized outputs for the web request status code and raw code text response.

### III.C.2. Setting Up the API Environment

A Just-in-Time Programming session may begin with a few setup steps. For example, an API key from OpenAI (or some other LLM or AI vendor) may be obtained by subscribing to their API services. This key may be used to authenticate requests to the GPT-4 model or other AI model. The API key may be stored securely within a key vault, which allows for the key to be retrieved and used as environment variable within a DataFlow. The base URL for the OpenAI API endpoints may be configured, for example, as described at https://api.openai.com/v1/.

### III.C.3. API Request Construction

The request to the GPT-4 model includes several parameters such as the prompt, maximum tokens, temperature, and top-p. These parameters control the model's behavior and the format of the response. These parameters can be pre-defined within the Just-in-Time Programming framework and can also be changed by the end-user.

End-users are able to craft and submit prompts that are specific to the tasks they wish to solve. Prompts should provide sufficient context to the LLM to generate accurate and relevant responses. Example:
Generate a Composable DataFlow workflow that aggregates sales data from multiple sources and generates a summary report.

In cases where specific data needs to be submitted to the LLM as part of the prompt, data may be formatted and included appropriately. This might involve converting the data into a string or JSON format that can be embedded in the prompt. An example data-enhanced prompt might appear as follows:

sales_data_summary = “““
Sales Data:
- Source 1: {“date”: “2023-06-01”, “sales”: 100}
- Source 2: {“date”: “2023-06-01”, “sales”: 150}
- Source 3: {“date”: “2023-06-01”, “sales”: 200}
Please generate a Composable workflow to aggregate this
sales data and create a summary report.
”””
prompt = “Generate a Composable DataFlow workflow to
process the following data: {sales_data_summary}”

API requests include any necessary request headers. This typically includes the API key for authentication and content-type headers. Example Headers:

```
{
  “Authorization”: “Bearer YOUR_OPENAI_API_KEY”,
  “Content-Type”: “application/json”
}
```

### III.C.4. Making the API Request and Handling the Result

A Just-in-Time Programming framework may include a built in module (task node) that utilizes an HTTP client library to send the web (REST API) request to the OpenAI API. An example set of inputs to the WebClient Module with the necessary parameters and header is shown below.

```
url = “https://api.openai.com/v1/engines/gpt-4/completions”
headers = {
  “Authorization″: f″Bearer {api_key}”,
  ″Content-Type″: ″application/json″
}
data = {
  ″prompt″: prompt,
  ″max_tokens″: 150,
  ″temperature″: 0.7,
  ″top_p″: 1.0
  }
```

The API response may be parsed to extract the generated text. This text represents the workflow code or the next steps in the data workflow.

### III.C.5. Integration into the Workflow

The generated text from the LLC may be reformed into a structured format that the Composable DataFlow engine can understand and execute as code. This may involve parsing JSON or another structured output format.

The generated text, to be used as code, may be used as an input in a subsequent task node (Module).

The explanation above has used OpenAI's GPT-¾ as an example of an LLM and has used the Composable DataFlow Platform as our Flow-Based Programming framework. Other LLMs and other Flow-Based Programming frameworks may be used to implement a Just-in-Time Programming system.

### III.C.6. Purpose-built LLM

While general LLMs can generate software code to some extent, as shown in the above examples with OpenAI's ChatGPT, a trained Language Model that generates software code and specifically trained on software source code outperforms them in terms of accuracy and contextual understanding. Specifically, LLMs that are trained a massive dataset of source code can capture code structures and coding conventions more comprehensively. As a result, it produces code that is more contextually appropriate, adheres to coding best practices, and aligns with the desired functionality. The domain-specific understanding of a purpose-built LLM may yield generated code of higher quality to meet the specific requirements of software development tasks. And more practically, the generated responses can contain just raw code, and not any extraneous text or language.

Also, as we saw in the above examples, as we move from simple algorithms (for arithmetic operations), to more complex algorithms (primality test), to complex data manipulation (finding duplicates), the generated code from the LLM becomes more complex. This requires an expert programmer to read the code, check it for accuracy, and test it.

So, while we can develop a trained Language Model for a single, or many, programming languages, such as C++, Java, C#, and Python, we take a different approach that leverages the Flow-Based Programming environment.

### III.C.7. Improving Reliability of Automated Code Generation

As with any other software development process, Just-in-Time Programming requires trust that the software performs its intended functions correctly and predictably, and that the resulting end-to-end system delivers accurate results, responds to inputs appropriately, and operates without unexpected failures or errors. To improve trust, the LLM may generate not just a block of text to be used as executable code, but rather generate a complete, visual, flow-based program, a visual algorithm that includes pre-defined functional blocks (Modules), to ensure consistency, accuracy and reliability. Our approach leverages two key features of Flow-Based Programming:
(a) Strongly Typed Modules: the Flow-Based Programming framework may enforce strong typing of modules, ensuring that data types are explicitly defined and consistent throughout the DataFlow.
(b) Loose Coupling: the Flow-Based Programming framework may promote loose coupling between modules, meaning that modules are decoupled from each other and communicate through well-defined data interfaces.

### III.D. Steps

Fine-tuning a pre-trained Large Language Model (LLM) with a large corpus of DataFlow code involves several steps to adapt the pre-trained model for specialized tasks. This process enhances the model's ability to understand, generate, and execute data workflows.

One approach to fine-tuning a Language Model that generates structured code representing Flow-Based Programs may proceed via the following steps:
1. Data Collection: A large dataset of human-generated Flow-Based Programs is collected from existing instances with Flow-Based programs developed by thousands of users. The Flow-Based Programs are converted to structured source code, as shown above.
2. Data Preprocessing: The structured source code is auto-generated, and may be of sufficient quality to be useable with fairly minimal pre-processing or cleansing. A human editor may remove any irrelevant comments or other types of irrelevant information.
3. Tokenization: We tokenize the code into appropriate units for modeling
   a. Tokens are based on method calls (e.g., statements for the Modules).
   b. We convert the tokenized code into numerical representations suitable for the model.
   c. We create a vocabulary mapping from tokens to unique integer IDs.
   d. We implement encoding and decoding functions to convert code snippets to and from numerical representations during training and generation.
4. Model Selection: A Just-in-Time Programming platform may use a Generative Pretrained Transformer (GPT) model.
   a. We initialize the LLM with pre-trained weights (e.g., GPT-3.5) to bootstrap the learning process.
5. Training: The model may be fine-tuned using the preprocessed dataset using self-supervised learning to predict the next token in a sequence given the previous context.
   a. We use an “unsupervised learning” training objective for the language model, for the model to learn to predict the next statement in a given sentence of statements based on the patterns and relationships in the training data.
6. Testing, Refinement and Validation: Just-in-Time Programming Platform and training of its language model may be improved using several metrics, including perplexity (degree of uncertainty), code correctness, and code style adherence. The training process may be iterated by fine-tuning the model and adjusting hyperparameters, and continuously evaluating the model until satisfactory results are achieved.

### III.E. Data Collection and Preparation

A large and diverse corpus of existing DataFlow code may be collected. This corpus preferably includes various data workflows, configurations, and usage patterns.

The corpus of collected data may be cleaned by removing any noise or irrelevant information. The corpus of existing DataFlow code may be annotated with metadata to provide context for each workflow. Metadata includes descriptions of the workflows, the types of tasks they perform, and any specific parameters or configurations used. This includes embedding workflow descriptions, usage scenarios, and any other relevant context that can help the model understand the purpose and structure of the code.

The data may be formatted to be compatible with the LLM's input requirements. This involves converting the workflows into a structured format that the model can process, such as JSON or plain text with clearly defined delimiters.

The corpus of existing DataFlow code may be tokenized using the tokenizer associated with the pre-trained LLM. This step converts the code into a sequence of tokens that the model can understand.

The sequence length may be managed to ensure that code templates fits within the model's maximum token limit. For long workflows, this may involve splitting the code into manageable chunks.

### III.F. Fine-Tuning Process

The model may be configured for fine-tuning by setting the appropriate hyperparameters. This includes learning rate, batch size, and the number of training epochs.

The training data may be prepared by creating input-output pairs. Inputs may include workflow prompts or partially completed workflows. Outputs may include corresponding code completions or next steps.

The fine-tuning process is executed using the prepared training data. This involves training the model to minimize the loss function, typically a form of cross-entropy loss, to improve its performance on the specific task of understanding and generating DataFlow code.

The model's performance may be validated using a separate validation set, and specifically verify its ability to generate accurate and contextually relevant workflow code. Hyperparameters can be adjusted, and model retraining can be performed as necessary.

Based on validation results, fine-tuning may be performed in an iterative fashion, by refining the training data and model configurations. This may involve additional rounds of data collection, annotation, and cleaning.

Iterative fine-tuning and strict validation is critical in having the model generate not just syntactically correct but also functionally correct DataFlows. An iterative approach to fine-tuning includes gradually introducing more complex DataFlow examples and incorporating feedback loops to correct errors. Validation checks during training, strong typing, and loose coupling principles, and flagging and correction of deviations during training iterations may improve code generation quality.

### III.G. Integration and Deployment

The fine-tuned model may be integrated into a graphical user interface DataFlow programming environment using API requests that allow the model to interact with the workflow execution engine.

A feedback loop may be configured where user interactions and feedback are used to continuously improve the model. This involves collecting data on the model's performance and retraining it periodically with new data.

### IV. Fine-Tuning Pre-Trained LLM for Composable DataFlow Code Generation

### IV.A. Mathematical Formulation

Fine-tuning a pre-trained language model involves adapting the model to a specific task or dataset by continuing the training process on the new, task-specific data. This process can be understood through the lens of transfer learning and involves several key concepts and mathematical principles.

Transfer Learning is the process of taking a model trained on a large, diverse dataset and adapting it to a specific task or domain. The main idea is to leverage the knowledge the model has acquired during its initial training (pre-training) and apply it to new tasks (fine-tuning). During the pre-training phase, the LLM is trained on a massive corpus of text using unsupervised learning. The objective is to learn general language patterns, structures, and representations. The training objective for models like GPT-4 is typically a language modeling objective, where the model learns to predict the next word in a sequence.

One possible mathematical formulation of this process involves minimizing the negative log-likelihood of the predicted tokens given the context:

$${ℒ}_{pre - train} = - {\sum }_{t = 1}^{T} log P ( {x}_{t} \vert {x}_{< t} ; θ )$$

where: xᵢ is the token at position t, x_{<t}, is the sequence of tokens before position t, and θ represents the model parameters.

During the fine-tuning phase, the pre-trained model is further trained on a smaller, task-specific dataset. This process uses supervised learning, where the model is optimized to perform well on the specific task.

The fine-tuning objective is to minimize the task-specific loss function. For example, if the task is text classification, the loss function might be the cross-entropy loss. If the task is text completion or code generation, as is the case here, the objective is to minimize the negative log-likelihood of the correct tokens.

The fine-tuning loss can be written as:

$${ℒ}_{fine - tune} = - {\sum }_{t = 1}^{T} log P ( {y}_{t} \vert {y}_{< t} , D ; θ )$$

where yₜ is the token at position t in the task-specific dataset, y_{<t} is the sequence of tokens before position t in the task-specific dataset, and D represents the task-specific dataset.

The optimization process involves updating the model parameters θ to minimize the fine-tuning loss. This is typically done using stochastic gradient descent (SGD) or its variants like Adam.

One possible parameter update rule for one step of gradient descent is:

$$θ ← θ - η {∇}_{θ} {ℒ}_{fine - tune}$$

where η is the learning rate and ∇_{θ} [symbol] _{fine-tune} is the gradient of the loss with respect to the model parameters.

Fine-tuning often includes regularization techniques to prevent overfitting, such as randomly dropping units (along with their connections) from the neural network during training and adding a penalty term to the loss function proportional to the norm of the weights.

The loss function with weight decay (L2 regularization) can be written as:

$${ℒ}_{fine - tune} = - {\sum }_{t = 1}^{T} log P ( {y}_{t} \vert {y}_{< t} , D ; θ ) + λ {‖ θ ‖}_{2}^{2}$$

where λ is the regularization parameter.

### IV.B. Approach

Here, we show that we can effectively tokenize the Composable DataFlow code, convert it into numerical representations suitable for the model, and implement encoding and decoding functions. This process ensures the model can understand and generate visual flow-based programs, enhancing trust and debuggability compared to traditional text-based code generation. Fine-tuning GPT-3.5 for Composable DataFlow code generation may include tokenizing a large corpus of Composable DataFlow code examples into a format suitable for GPT-3.5 and (fine-tuning) using a supervised learning setup where the model is trained to predict the next component of the DataFlow given the previous components.

Tokenization is the process of breaking down the code into discrete units (tokens) that can be used for modeling. This process involves several steps to ensure the tokens are appropriate for the task and the model can process them effectively. In the context of DataFlow programs, these tokens include module names, operators, control structures, and the data types of the module inputs and outputs. In the context of code generation, tokens can include method calls, variable names, operators, keywords, and other syntactic elements. In cases where Just-in-Time programming is implemented as a visual, flow-based programming language, tokenization can be treated as a typical “code generation” problem, with each punctuation mark, module or functional block treated as a token. This approach ensures that the model captures the logical structure and flow of the DataFlow.

For example, assuming the Direct Acyclic Graph (DAG) of a DataFlow can be written as a sequence of functional blocks, for example DataFlow=[Module1, Module2, Module3], the tokenized code is Tokens=[′DataFlow′, ‘=’, ‘[’, ‘Module1’, ‘,’, ‘Module2’, ‘,’, ‘Module3’, ‘]’]. We can then convert the tokenized code into numerical representations. Each token is converted into a numerical format that the model can process. This involves mapping each token to a unique integer ID. For example, for Tokens=[′DataFlow′, ‘=’, ‘[’, ‘Module1’, ‘,’, ‘Module2’, ‘,’ ‘Module3’, ‘]’], and the numerical representation is NumericalTokens=[1, 2, 3, 4, 5, 6, 5, 7, 8]. Next, we can create a vocabulary mapping from tokens to unique integer IDs. Vocabulary Mapping is a crucial part of the tokenization process, as it establishes a correspondence between the tokens (which are derived from the code) and unique integer IDs that the model can process. We are careful to ensure consistency, so the same token always maps to the same integer ID and vice versa.

As an example, assuming a simple DataFlow involving modules for data input, processing, and output. Here's an example of such a DataFlow:

```
(pseudocode for a simple DataFlow)
DataFlow = [
  InputModule(“ReadCSV”),
  ProcessingModule(“FilterData”),
  OutputModule(“WriteCSV”)
]
```

The tokens in the above DataFlow include:

Keywords: ‘DataFlow’, ‘InputModule’, ‘ProcessingModule’,
‘OutputModule’
Literals: ‘″ReadCSV″‘, ‘″FilterData″‘, ‘″WriteCSV″‘
Symbols: ‘=‘, ‘[‘, ‘]‘, ‘(‘, ‘)‘

To create a dictionary, we assign a unique integer ID to each token:

```
Vocabulary = {
  ‘DataFlow’: 1,
  ‘=’: 2,
  ‘[’: 3,
  ‘InputModule’: 4,
  ‘ProcessingModule’: 5,
  ‘OutputModule’: 6,
  ‘(’: 7,
  ‘“ReadCSV”’: 8,
  ‘)’: 9,
  ‘,’: 10,
  ‘“FilterData”’: 11,
  ‘“WriteCSV”’: 12,
  ‘]’: 13
}
```

Finally, we implement the encoding and decoding functions. The encoding function converts code snippets (in tokenized form) into numerical representations using the vocabulary mapping. The decoding function converts numerical representations back into tokenized code snippets. As an example, using the Python programming language, the encoding and decoding functions are:

```
def encode(tokens, vocabulary):
  return [vocabulary[token] for token in tokens]
def decode(numerical_tokens, vocabulary):
  inv_vocab = {v: k for k, v in vocabulary.items( )}
  return [inv_vocab[num] for num in numerical_tokens]
and the usage would be as follows:
tokens = [‘DataFlow’, ‘=’, ‘[’, ‘InputModule’, ‘(’, ‘“ReadCSV”’,
‘)’, ‘,’, ‘ProcessingModule’, ‘(’, ‘“FilterData”’, ‘)’, ‘,’,
‘OutputModule’, ‘(’, ‘“WriteCSV”’, ‘)’, ‘]’]
numerical_tokens = encode(tokens, Vocabulary)
decoded_tokens = decode(numerical_tokens, Vocabulary)
```

### IV.C. Structured Tokenization Techniques

We further show structured tokenization as a robust method for ensuring the accuracy, reliability, and trustworthiness of the generated DataFlows. These advanced tokenization techniques ensure that the LLM can generate and understand complex DataFlows with high accuracy and contextual relevance. This is particularly important when generating flow-based programs where the generated code must be both syntactically correct and functionally correct, by capturing the hierarchical and interconnected nature of the DataFlows.

Hierarchical tokenization breaks down the DataFlow into hierarchical levels, where each module and its connections are tokenized separately. This is critical because it breaks down the DataFlow into manageable levels of granularity, from top-level structure to individual modules and their connections and ensures that each component of the DataFlow is independently tokenized, making it easier to process and understand.

Context-Aware Tokens allow for including contextual information as part of the tokens to preserve the relationships between modules. For example, a token for a connection includes information about the source and destination modules. This enhances the model's ability to generate accurate and contextually appropriate DataFlows by including details about module connections and types.

Hierarchical tokenization involves breaking down a complex DataFlow structure into multiple levels of granularity. We define three levels of a flow-based program:
1. Top-Level Structure: The overall flow, including the sequence of modules and their connections.
2. Module Level: Each individual module, its type, and its properties.
3. Connection Level: The connections between modules, specifying the data flow from one module to another.

As an example, we take a simple DataFlow with three modules: ‘Input’, ‘Processing’, and ‘Output’. The ‘Processing’ module takes data from ‘Input’, processes it, and sends the result to ‘Output’. We break this down into:

```
Top-Level Structure:
  Start of DataFlow
  Modules: Input -> Processing -> Output
  Module Level
    ‘Input’ Module: Type = “DataSource”, Properties = {Source: “File”,
    Path: “/data/input.csv”}
    ‘Processing’ Module: Type = “Filter”, Properties = {Condition:
    “value > 10”}
    ‘Output’ Module: Type = “DataSink”, Properties = {Destination:
    “Database”, Table: “Results”}
  Connection Level
    Connection 1: Source = ‘Input’, Destination = ‘Processing’, Data =
    {Fields: [“value”]}
    Connection 2: Source = ‘Processing’, Destination = ‘Output’, Data =
    {Fields: [“filtered_value”]}
```

We can then define the following tokens:

Top-Level Tokens
[START_FLOW]
[MODULE] Input
[MODULE] Processing
[MODULE] Output
[END_FLOW]
Module Level Tokens
[MODULE_INPUT] [TYPE] DataSource [PROPERTY]
Source: File [PROPERTY] Path: /data/input.csv
[MODULE_PROCESSING] [TYPE] Filter
[PROPERTY] Condition: value > 10
[MODULE_OUTPUT] [TYPE] DataSink [PROPERTY]
Destination: Database [PROPERTY] Table: Results
Connection Level Tokens
[CONNECTION] [SOURCE] Input [DESTINATION]
Processing [DATA] Fields: value
[CONNECTION] [SOURCE] Processing
[DESTINATION] Output [DATA] Fields: filtered_value

Context-aware tokens include additional information to preserve the relationships between components. In a DataFlow, this means including the context of connections (i.e., which modules are connected and how). Using the previous example, we can add context-aware tokens as follows.

```
Module Tokens with Context
  [MODULE_INPUT] [TYPE] DataSource [PROPERTY]
  Source: File [PROPERTY] Path: /data/input.csv [CONTEXT]
  ConnectedTo: Processing
  [MODULE_PROCESSING] [TYPE] Filter [PROPERTY]
  Condition: value > 10 [CONTEXT] ConnectedFrom: Input,
  ConnectedTo: Output
  [MODULE_OUTPUT] [TYPE] DataSink [PROPERTY]
  Destination: Database [PROPERTY] Table: Results
  [CONTEXT] ConnectedFrom: Processing
  Connection Tokens with Context
  [CONNECTION] [SOURCE] Input [DESTINATION]
  Processing [DATA] Fields: value [CONTEXT] SourceType:
  DataSource, DestinationType: Filter
  [CONNECTION] [SOURCE] Processing [DESTINATION]
  Output [DATA] Fields: filtered_value [CONTEXT]
  SourceType: Filter, DestinationType: DataSink
```

Finally, we illustrate this structured tokenization with a more complex DataFlow example that includes a conditional branching in the DataFlow.
DataFlow
   1. Input Module (reads data)
   2. Filter Module (filters data)
   3. Branch Module (splits data based on condition)
   4. Aggregation Module (aggregates filtered data)
   5. Output Module (writes data)

### Tokenization

```
Top-Level Tokens:
    [START_FLOW]
  [MODULE] Input
  [MODULE] Filter
  [MODULE] Branch
  [MODULE] Aggregation
  [MODULE] Output
  [END_FLOW]
Module Level Tokens:
  [MODULE_INPUT] [TYPE] DataSource [PROPERTY] Source: File
  [PROPERTY] Path: /data/input.csv [CONTEXT] ConnectedTo: Filter
  [MODULE_FILTER] [TYPE] Filter [PROPERTY] Condition: value >
  10
  [CONTEXT] ConnectedFrom: Input, ConnectedTo: Branch
  [MODULE_BRANCH] [TYPE] Conditional [PROPERTY] Condition:
  value % 2 == 0 [CONTEXT] ConnectedFrom: Filter, ConnectedTo:
  Aggregation
  [MODULE_AGGREGATION] [TYPE] Aggregator [PROPERTY]
  Function: Sum [CONTEXT] ConnectedFrom: Branch, ConnectedTo:
  Output
  [MODULE_OUTPUT] [TYPE] DataSink [PROPERTY] Destination:
  Database [PROPERTY] Table: Results [CONTEXT] ConnectedFrom:
  Aggregation
Connection Level Tokens:
  [CONNECTION] [SOURCE] Input [DESTINATION] Filter [DATA]
  Fields: value [CONTEXT] SourceType: DataSource, DestinationType:
  Filter
  [CONNECTION] [SOURCE] Filter [DESTINATION] Branch [DATA]
  Fields: filtered_value [CONTEXT] SourceType: Filter,
  DestinationType: Conditional
  [CONNECTION] [SOURCE] Branch [DESTINATION] Aggregation
  [DATA] Fields: filtered_value [CONTEXT] SourceType: Conditional,
  DestinationType: Aggregator
  [CONNECTION] [SOURCE] Aggregation [DESTINATION] Output
  [DATA] Fields: aggregated_value [CONTEXT] SourceType:
  Aggregator, DestinationType: DataSink
```

### V. Implementation

Just-in-Time Programming may be implemented as a cloud-based platform that provides users with a web-based interface for interacting with the framework. The platform may include a set of servers that host the framework and provide computing resources for executing user tasks.

The Just-in-Time Programming framework may include a graphical user interface (GUI) that allows users to interact with the framework through a visual and intuitive interface. The GUI enables users to drag and drop modules, connect them together, and define the logic of their tasks visually. The GUI also provides real-time feedback on the performance and efficiency of user algorithms, enabling users to iterate and refine their code in real time.

The Just-in-Time Programming framework may include a library of pre-defined modules that cover common programming tasks and algorithms. These modules are designed to be modular, reusable, and scalable, allowing users to create complex workflows by connecting simple and self-contained modules. The framework also includes a module marketplace where users can browse and download additional modules created by other users or third-party developers.

The Just-in-Time Programming framework may also include a set of collaboration tools that enable real-time collaboration among users working on the same task. These tools include comment functionality, version control, and shared workspaces, allowing users to work together seamlessly and efficiently.

The Just-in-Time Programming framework may include a set of APIs and SDKs that allow developers to extend the functionality of the framework and integrate it with other software systems. These APIs and SDKs enable developers to create custom modules, integrate third-party services, and build complex applications that leverage the power of the Just-in-Time Programming framework.

The Just-in-Time Programming framework may include a set of debugging and monitoring tools that enable users to identify and address issues in their code. These tools may provide real-time feedback on the performance and efficiency of user algorithms, helping users to optimize their code and improve task completion times.

The Just-in-Time Programming framework may include support for additional programming paradigms beyond Flow-Based Programming. For example, the framework could incorporate aspects of procedural, object-oriented, or functional programming paradigms to provide users with a more diverse set of tools and approaches for implementing algorithms in real time. This could involve integrating libraries or modules that support these paradigms, allowing users to choose the programming style that best suits their needs.

The Just-in-Time Programming framework may include support for different types of Large Language Models (LLMs) or artificial intelligence (AI) models. While the preferred embodiment focuses on using LLMs for code generation and task automation, alternative embodiments could leverage other types of AI models for specific tasks, such as image recognition, natural language processing, or data analysis. By incorporating a variety of AI models, the framework could provide users with a more versatile toolkit for implementing algorithms in real time.

The Just-in-Time Programming framework may include different user interfaces or interaction models. For example, the framework could offer a command-line interface (CLI) for users who prefer text-based interactions, or a voice-activated interface for users who prefer hands-free operation. These alternative interfaces could enhance the accessibility and usability of the framework for users with different preferences or accessibility needs.

Furthermore, alternative embodiments could explore different deployment models for the Just-in-Time Programming framework. For example, the framework could be deployed as a standalone application, a plug-in for existing development environments, or a cloud-based service. Each deployment model could offer different advantages in terms of scalability, accessibility, and integration with other software systems.

Any of the various processes described herein may be implemented by appropriately programmed general purpose computers, special purpose computers, and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogenous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

A server computer or centralized authority may or may not be necessary or desirable. In various cases, the network may or may not include a central authority device. Various processing functions may be performed on a central authority server, one of several distributed servers, or other distributed devices

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer.

The invention claimed is:

1. A computer system, comprising:
one or more processors designed to execute instructions from a memory;
one or more computer-readable nontransitory memories having stored therein instructions to cause the processor(s) to:
as users of a programming system use the programming system to create programs, to store into a computer memory data describing actions of the users in creating the programs, the programming system having a graphical user interface and a library of templates for functions, the graphical user interface presenting to users functions depicted as templates of blocks to be selected for incorporation into programs, the graphical user interface being programmed to receive input from the users to direct the system to assemble functions from the set into the programs, the functions being functions for processing of data, the graphical user interface depicting the incorporated functions as graphical elements for manipulation in the graphical user interface, the graphical user interface presenting an ability to graphically connect data output connection points of incorporated function graphical elements to input connection points of incorporated function graphical elements; and
a trained artificial intelligence large language model, the model having been trained with a corpus of graphical programs to compute suggestions to the user for functions to be added into the program, the computation of function suggestion being based at least in part on a prompt given by the user and the trained large language model.

2. The computer system of claim 1, the instructions being further programmed to cause the processor(s) to:
as the user assembles functions from the set into a program, execute a partially-assembled program on input data; and
compute suggestions to the user for functions to be added into the program based at least in part on the execution of the partially-assembled program.

3. The computer system of claim 1, wherein:
the corpus of existing graphical programs has been annotated with metadata to provide context for incorporation into programs to be created.

4. The computer system of claim 1, wherein:
the corpus of existing graphical programs has been tokenized to integer IDs.

5. The computer system of claim 1:
wherein the function templates of the corpus specify inputs and outputs, the inputs and outputs being strongly typed; and
the instructions being further programmed to cause the computer to compute the function suggestions based at least in part on the types of inputs and/or outputs of the functions in the program.

6. The computer system of claim 1, the instructions being further programmed to cause the processor(s) to:
compute a training objective that minimizes negative log-likelihood of suggested actions.

7. The computer system of claim 1, the instructions being further programmed to cause the processor(s) to:
gather feedback for retraining of the artificial intelligence large language model.

8. A method, comprising the steps of:
as users of a programming system use the programming system, running on a processor of a computer system, to create programs, storing into a computer memory data describing actions of the users in creating the programs, the programming system having a graphical user interface and a library of templates for functions, the graphical user interface presenting to users functions depicted as templates of blocks to be selected for incorporation into programs, the graphical user interface being programmed to receive input from the users to direct the system to assemble functions from the set into the programs, the functions being functions for processing of data, the graphical user interface depicting the incorporated functions as graphical elements for manipulation in the graphical user interface, the graphical user interface presenting an ability to graphically connect data output connection points of incorporated function graphical elements to input connection points of incorporated function graphical elements; and
using a trained artificial intelligence large language model, the model having been trained with a corpus of graphical programs, to compute suggestions to the user for functions to be added into the program, the computation of function suggestion being based at least in part on a prompt given by the user and the trained large language model.

9. The method of claim 8, further comprising the steps of:
as the user assembles functions from the set into a program, executing a partially-assembled program on input data; and
computing suggestions to the user for functions to be added into the program based at least in part on the execution of the partially-assembled program.

10. The method of claim 8, wherein:
the corpus of existing graphical programs has been annotated with metadata to provide context for incorporation into programs to be created.

11. The method of claim 8, wherein:
the corpus of existing graphical programs has been tokenized to integer IDs.

12. The method of claim 8:
wherein the function templates of the corpus specify inputs and outputs, the inputs and outputs being strongly typed; and
further comprising the step of causing the computer to compute the function suggestions based at least in part on the types of inputs and/or outputs of the functions in the program.

13. The method of claim 8, further comprising the steps of:
computing a training objective that minimizes negative log-likelihood of suggested actions.

14. The method of claim 8, further comprising the steps of:
gathering feedback for retraining of the artificial intelligence large language model.
